(19) United States
(12) Patent Application Publication
(10) Pub. No.: US 2026/0220016 A1
(43) Pub. Date: Jul. 30, 2026

(54) TECHNIQUES FOR STATE MONITORING AND CONTROL

(71) Applicant: N-ABLE, Wakefield, MA (US)

(72) Inventors: Alan Maclennan Keir, Duns (GB); Nicole Catherine Reineke, Northboro, MA (US); Michael I. Adler, Framingham, MA (US)

(21) Appl. No.: 19/041,084

(22) Filed: Jan. 30, 2025

(51) Int. Cl. G06F 11/07; G06F 11/32

(52) U.S. Cl. CPC G06F 11/3447; G06F 11/3428

(57) ABSTRACT

This disclosure describes techniques for state monitoring and control of components in a client system. More specifically, embodiments are directed to an EM system that intelligently monitors and controls the states of components in a client system by determining drift from target states for components based on an ethos of the client. For example, the EM system may identify a target state model of a component in a set of components of a client system, determine a current drift of the component based on the target state model, and trigger remedial action in the client system in response to determining the current drift of the component exceeds a threshold level of current drift.

### FIELD OF DISCLOSURE

This disclosure is related generally to state monitoring and control and more particularly to an ethos management (EM) system for intelligent state monitoring and control automation.

### BACKGROUND

Managed services may refer to the practice of outsourcing the responsibility for maintaining, and anticipating need for, a range of processes, functions, systems, devices, perceptions, attitudes, and the like (collectively referred to as components or managed components), ostensibly for the purpose of improved operations and reduced budgetary expenditures through the reduction of directly-employed staff. The external organization may be referred to as a managed service(s) provider (MSP) and the organization receiving the services may be referred to as the client. The services provided by an MSP may include information services, cloud services, business-to-business integration services, supply chain managed services, marketing services, media services, technical support services, and the like. A major aspect of providing these services is keeping managed components in a target, or desired, state.

Oftentimes MSPs are required to make important resource and service tradeoff decisions for their clients in order to maintain managed components as close as possible to a target state as practical. These decisions can be as simple as which hardware should be acquired in the upcoming fiscal year, or as complex as which user is the least satisfied with their experience and who should be assigned to the next available support technician for assistance. These decisions, however, are subjective. In other words, different MSP clients have different views of what is important because of the numerous factors that go into determining what is important. For example, the priorities of an MSP client may be based on physical location, culture, task, missions, goals, values, and the like.

### BRIEF DESCRIPTION OF THE DRAWINGS

The present disclosure will be understood more fully from the detailed description given below and from the accompanying drawings of various embodiments, which, however, should not be taken to limit the embodiments described and illustrated herein, but are for explanation and understanding only.

To easily identify the discussion of any particular element or act, the most significant digit or digits in a reference number refer to the figure number in which that element is first introduced.

FIG. 1 illustrates a block diagram of an exemplary system architecture for state monitoring and control according to some embodiments of the current disclosure.

FIG. 2 illustrates exemplary functional modules of an ethos management (EM) system according to some embodiments of the current disclosure.

FIG. 3 illustrates exemplary aspects of client system data according to some embodiments of the current disclosure.

FIG. 4 illustrates exemplary aspects of a client ethos according to some embodiments of the current disclosure.

FIG. 5 illustrates exemplary aspects of a target component state according to some embodiments of the current disclosure.

FIG. 6 illustrates an exemplary process flow for setting up an EM system according to some embodiments of the current disclosure.

FIG. 7 illustrates various aspects of a system manager according to some embodiments of the current disclosure.

FIG. 8 illustrates various aspects of a state monitor of an EM system according to some embodiments of the current disclosure.

FIG. 9 illustrates various aspects of a drift administrator of an EM system according to some embodiments of the current disclosure.

FIG. 10 illustrates exemplary aspects of a state space according to some embodiments of the current disclosure.

FIG. 11 illustrates an exemplary drift graphical user interface (GUI) view according to some embodiments of the current disclosure.

FIG. 12 illustrates an exemplary process flow for monitoring and controlling component state based on drift according to some embodiments of the current disclosure.

FIGS. 13A and 13B illustrate various functional aspects of an EM system according to some embodiments of the current disclosure.

FIG. 14 illustrates a logic flow of an exemplary method for dynamic state monitoring and control according to some embodiments of the current disclosure.

FIG. 15 is one embodiment of a computer system that may be used to support the systems and operations discussed herein.

### DETAILED DESCRIPTION

In the following description, numerous details are set forth. It will be apparent, however, to one of ordinary skill in the art having the benefit of this disclosure, that the embodiments described herein may be practiced without these specific details. In some instances, well-known structures and devices are shown in block diagram form, rather than in detail, in order to avoid obscuring the embodiments described herein.

Some portions of the detailed description that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “identifying”, “determining”, “triggering”, “defining”, “generating”, “projecting”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The embodiments discussed herein may also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, quantum memory, quantum-mechanical memory, or any type of media suitable for storing electronic instructions.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the embodiments discussed herein are not described with reference to any particular programming language. It will be appreciated that a variety of programming languages may be used to implement the teachings as described herein.

Generally, this disclosure describes techniques for state monitoring and control of components in a client system. More specifically, embodiments are directed to an EM system that intelligently monitors and controls the states of components in a client system by determining drift from target states for components based on an ethos of the client. For example, the EM system may identify a target state model of a component in a set of components of a client system, determine a current drift of the component based on the target state model, and trigger remedial action in the client system in response to determining the current drift of the component exceeds a threshold level of current drift. These and other embodiments are described and claimed.

Existing systems for state monitoring and control fail to monitor and control components in a client system in a customized, accurate, reliable, and efficient manner. For example, different clients have a different view of what is important. Further, with large clients, each of their sites may have a different set of priorities, missions, goals, values, and the like (collectively referred to as ethos) based on various factors, such as physical location, culture, task, environment, security requirements, compliance requirements, and usability requirements. Existing systems, however, are not capable of adapting the state monitoring and control according to the different sets of priorities, missions, goals, values, and the like of different clients. In other words, existing systems fail to make recommendations, determinations, and decisions on behalf of clients that are in alignment with the ethos of the client and/or portions of the client.

Adding further complexity, a plurality of client systems, and the components thereof, need to be maintained as close to a target state as possible with limited resources. For example, unlimited resources are not available to immediately respond to each issue as soon as it occurs. However, existing systems fail to intelligently allocate the limited resources in an efficient manner, such as by handling issues in a first in, first out (FIFO) manner. For example, the pending failure of a battery backup unit may be much more important to a first client that suffers frequent power disruptions than to a second client that does not suffer frequent power disruptions. However, existing systems cannot leverage this difference in client ethos to prioritize resources for the resolution of the battery backup unit for the first client over the second client based on the ethos of the client.

Still further, existing systems are inefficient and lacking in their methods of state monitoring and control automation. For example, existing systems may identify an issue, but require manual intervention (e.g., by a subject matter expert) to identify the cause of the issue and/or ways to resolve the issue. Furthermore, existing systems fail to track system activities and inputs and utilize them to improve future system performance, such as through continuous learning. These limitations can drastically reduce the desirability and usability of state monitoring and control systems, contributing to systems that are unreliable, inefficient, and rigid, resulting in ineffective systems, devices, and techniques with limited capabilities.

Accordingly, many embodiments disclosed herein provide an ethos management (EM) system that provides state monitoring and control in a customized, accurate, reliable, and efficient manner. In various embodiments, the EM system may achieve this by providing one or more of continuous monitoring, proactive interventions, feedback loops, personalization, and transparency. Continuous monitoring may include regularly measuring attributes defined by a target state to identify areas where components of a client system (e.g., devices, user satisfaction, or sentiment) are drifting from the target state. Proactive interventions may include utilizing identified drifts to trigger automated or semi-automated actions aimed at realigning with the target state, such as deploying additional resources, initiating targeted user training, or adjusting service delivery approaches. Feedback loops may include integrated mechanisms to collect and analyze feedback continuously. In many embodiments, this feedback may be utilized to refine the target states and ensure target states remain aligned with client expectations and evolving needs. Personalization may include tailoring services and support to individual user needs and preferences, leveraging data from target state monitoring to personalize the user experience further. Transparency may refer to keeping users and clients informed about actions taken to maintain or restore target state, and the rationale behind the actions, fostering trust and transparency in the client-provider relationship.

To achieve these and other objectives, various embodiments determine an ethos of a client in a manner that can be leveraged as a mechanism for weighing priority and decision making for state monitoring and control. For example, the ethos of a client may include a set of objectives for a client and each objective may be defined by a data structure comprising a hierarchical arrangement of attributes, facts, metrics, and expected values. In several embodiments, the EM system may implement a guided user interface flow to determine the ethos for a client. In many embodiments, ethos may be used to automatically determine a target state, or template target state, for a component and weightings utilized to calculate drift (e.g., distance) of the component from the target state. For example, if a client ethos places the highest priority on security, the EM system would weigh the dimensions of patch level on an application of a component as the highest value. In such examples, this results in an issue with a patch level causing more drift than an issue associated with processing power available to the component. In various embodiments, the drift of a component can be quantified in terms of the heightened risk of its non-compliance with ethos objectives. The homogeneous constituents of this risk formulation can then be utilized to construct a multi-dimensional vector space and used in conjunction with a machine learning model, which may be a drift model. In many embodiments, the EM system may identify causes of drift using distance and similarity vector calculations performed in multi-dimensional vector space. In some embodiments, drift projections may be determined for components and utilized to anticipate upcoming issues and/or needs. In many embodiments, the EM system may provide an improved user interface that allows users to intuitively utilize the capabilities of the EM system. For example, users may be able to cause the system to generate a graphical view of drift for a set of components. In another example, the EM system may enable users to perform specific queries associated with drift, such as to assist in determining which laptops to replace. In yet another example, users may be able to adjust one or more configurations and/or settings of the system, such as by modifying ethos, target states, or weightings. Various embodiments may recommend and/or trigger remedial actions based on the client ethos. The remedial actions may be utilized to remediate or mitigate drift of components from their target state. For example, remedial actions may reduce or eliminate drift of a component from a target state. Several embodiments may track system activities and inputs and utilize them to improve future system performance, such as through continuous learning. For example, the effect of a remedial action on the drift of a component may be determined and utilized to recommend additional remedial actions and/or adjust future remedial action recommendations. In another example, remedial action options may be presented for selection and the remedial action selected may be utilized to adjust future remedial action recommendations.

In these and other ways, components/techniques described herein provide many technical advantages. For instance, the computer-based techniques of the current disclosure increase the capabilities, practicality, adaptability, and efficiency of state monitoring and control systems thereby providing new and useful computer functionality for maintaining components of a client system. Additionally, the computer-based techniques of the current disclosure provide a valuable tool for identifying, prioritizing, and remedying issues with components in a client system, resulting in better system performance that aligns with client ethos. Accordingly, embodiments disclosed herein can be practically utilized to improve the functioning of a computer and/or to improve a variety of technical fields including state monitoring, state control, drift, machine learning, continual learning, automation, and/or user experience/capabilities.

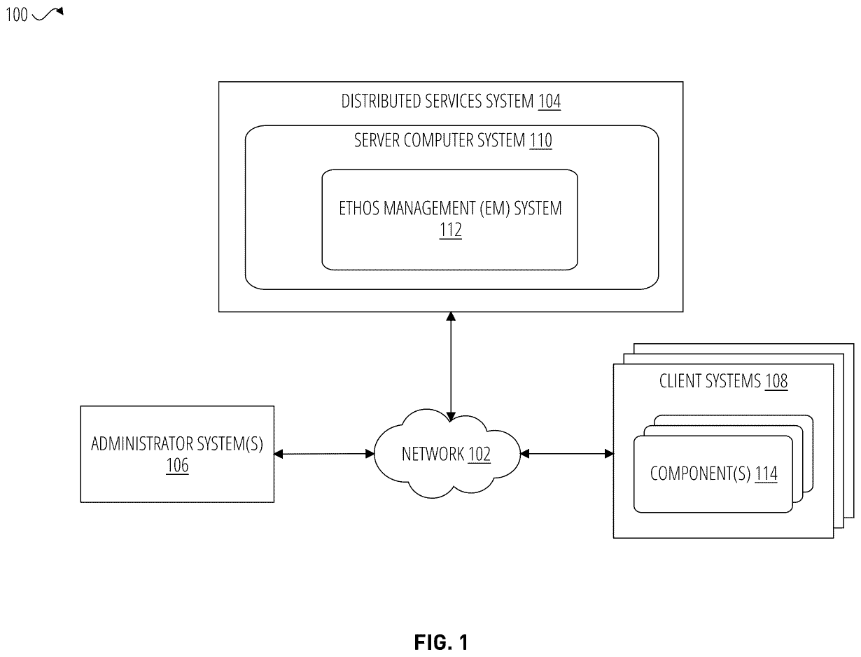

FIG. 1 is a block diagram of an exemplary system architecture 100 for state monitoring and control according to some embodiments. In one embodiment, the system 100 includes one or more distributed services systems 104, one or more client systems 108, and one or more administrator systems 106. In one embodiment, one or more systems (e.g., systems 104, 106, 108), or portions thereof (e.g., components 114), may be mobile computing devices, such as a smartphone, tablet computer, smartwatch, etc., as well as networks, infrastructure devices, or computer systems, such as a desktop computer system, laptop computer system, server computer systems, routers, etc. The one or more systems (e.g., systems 104, 106, 108), or portions thereof (e.g., components 114) may also be one or more computing devices, such as one or more server computer systems, desktop computer systems, etc. Furthermore, there may be any number of administrator systems 106 and/or client systems 108 utilizing the services of the distributed services systems 104. However, to avoid obscuring the present description, only one distributed services system 104, administrator system 106, and client systems 108 are generally illustrated and described.

Furthermore, it should be appreciated that the embodiments discussed herein may be utilized by a plurality of different types of platform computer systems, such as managed service provider (MSP) platform system(s), enterprise platform system(s), inventory platform system(s), media access and control system(s), resource platform system(s), card authorization platform system(s), payment processing platform system(s), gaming platform system(s), social media platform platform(s), and other systems. Then the distributed services system 104 can include a plurality of service processing systems (not shown) that are distributed systems that perform the functions that provide the one or more services of the distributed services system 104. Furthermore, any system seeking to implement state monitoring and control (e.g., via EM system 112) may use and/or extend the techniques discussed herein to improve efficiency, scalability, and/or capabilities of state monitoring and control systems (e.g., EM system 112). However, to avoid obscuring the embodiments discussed herein, state monitoring and control via EM system 112), is discussed to illustrate and describe the embodiments of the present invention, and is not intended to limit the application of the techniques described herein to other systems in which state monitoring and control could be used.

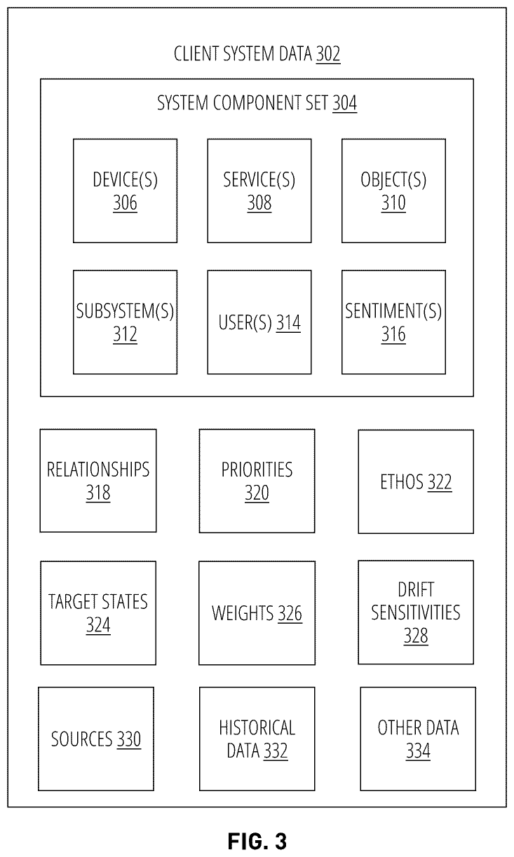

The distributed services system 104, client systems 108, and administrator system 106 may be coupled to a network 102 and communicate with one another using any of the standard protocols for the exchange of information, including secure communication protocols. In one embodiment, one or more of the distributed services system 104, client systems 108, and administrator system 106, or components thereof (e.g., components 114), may run on one Local Area Network (LAN) and may be incorporated into the same physical or logical system, or different physical or logical systems. Alternatively, the distributed services system 104, client systems 108, and administrator system 106, or components thereof (e.g., components 114), may reside on different LANs, wide area networks, cellular telephone networks, clouds, satellite networks, etc. that may be coupled together via the Internet but separated by firewalls, routers, and/or other network devices. In one embodiment, distributed services system 104 may reside on a single server, or be distributed among different servers, coupled to other devices via a public network (e.g., the Internet) or a private network (e.g., LAN). It should be noted that various other network configurations can be used including, for example, hosted configurations, distributed configurations, centralized configurations, etc. As discussed in more detail below, such as with respect to FIG. 3, the components 114 of client systems 108 may include physical components (e.g., computing devices) as well as non-physical components (e.g., sentiments, attitudes, network speed, onboarding processes (e.g., new user onboarding), and the like) that are monitored and/or controlled by EM system 112.

To monitor and/or control the state of components 114 in an efficient, scalable, actionable, and intelligent manner, in embodiments, distributed services system 104 utilize a server computer system 110 including an ethos management system (e.g., EM system 112). In various embodiments, the server computer system 110 may include one or more server computer systems. For example, various functionalities described hereby may be broken into microservices that may run on edge devices that are managed by the EM system. In one such example, a mini EM system (e.g., a portion of a larger EM system) may run on a computing device in space (e.g., a satellite). In some such examples, when the mini EM system gets an internet connection, it may connect back to the larger EM system for updates. As will be discussed in greater detail below, the EM system 112 may intelligently monitor and/or control the states of components 114 in client systems 108 by determining drift from target states for components 114 based on an ethos of the client associated with each of the client systems. For example, the EM system 112 may identify a target state model of a component in a set of components of a client system, determine a current drift of the component based on the target state model (e.g., drift model), and trigger remedial action in the client system in response to determining the current drift of the component exceeds a threshold level of current drift.

In many embodiments, the EM system 112 may receive input from and communicate output to administrator system 106, client systems 108, and one or more components 114, such as to configure the EM system 112, monitor the state of components 114, and/or implement remedial actions in an intelligent and automated way. In the illustrated embodiment, the components 114 are included in the client systems 108. However, in additional, or alternative embodiment, the components 114 may be included in administrator system 106, distributed services system 104, and/or third-party systems (e.g., cloud providers) without departing from the scope of this disclosure. In some examples, the EM system 112 and components 114 operate substantially independently from each other. Thus, one or more embodiments described herein generally decouple state monitoring and control for components 114 (which may be performed by EM system 112) from enterprise functionalities/purpose/indication provided by the components 114. For example, EM system 112 may monitor drift from a target state for the components 114 without as little impact as practical to the enterprise functionality of the components 114. In some embodiments, one or more of the components 114 may include a daemon communicatively coupled to the EM system 112 for monitoring and control purposes.

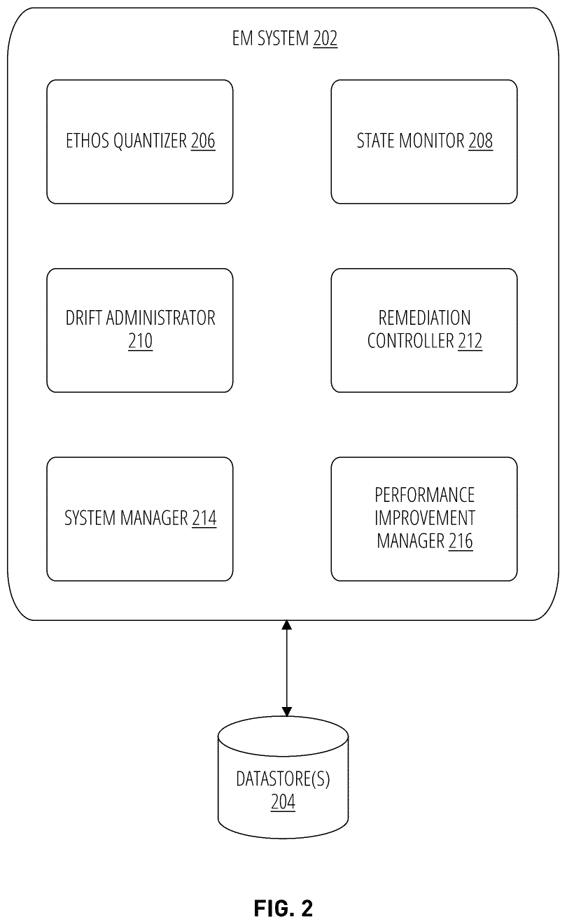

FIG. 2 illustrates exemplary functional modules of an EM system 202 according to some embodiments. In the illustrated embodiment, the EM system 202 is communicatively coupled to datastores 204 and includes an ethos quantizer 206, a state monitor 208, a drift administrator 210, a remediation controller 212, a system manager 214, and a performance improvement manager 216. In various embodiments, the functional modules of EM system 202 may interoperate to provide state monitoring and control for a plurality of client systems and client system components in a customized, accurate, reliable, and efficient manner. It will be appreciated that one or more components of FIG. 2 may be the same or similar to one or more other components disclosed herein. For example, EM system 202 may be the same or similar to EM system 112. Further, aspects discussed with respect to various components in FIG. 2 may be implemented by one or more other components from one or more other embodiments without departing from the scope of this disclosure. For example, datastores 204 may be implemented by server computer system 110 without departing from the scope of this disclosure. Embodiments are not limited in this context.

In many embodiments, EM systems 202 interoperate to implement techniques that provide state monitoring and control for a plurality of client systems and client system components in an intelligent and more capable manner. For example, the ethos quantizer 206 of EM system 202 may determine an ethos of a client in a manner that can be leveraged as a mechanism for weighing priority and decision making for state monitoring and control. In several embodiments, the ethos quantizer 206 of EM system 202 may implement a guided user interface flow to determine the ethos for a client.

In many embodiments, ethos may be utilized by the ethos quantizer 206 to automatically determine a target state, or template target state, for a component and weightings utilized to calculate drift (e.g., distance) of the component from the target state. Drift for a component may be determined by drift administrator 210 based on a current state of the component, as determined by state monitor 208. In some scenarios the attributes, facts, metrics, values, etc. of a component may be simply measured as true/false. For example, a patch is either version 24.3.2 or not. However, other situations determining drift are more complicated. In some of these scenarios drift can be a measurement of a distance from an expected value. For example, if a hard drive is expected to have 50% or more free space and the hard drive has 40% free space, then the drift may be 10% (i.e., 50%-10%). However, if the hard drive has 0% free space, the drift may be 50%. In many embodiments, these values may get normalized to a value between zero and one. For example, 10% may be normalized to 0.2 and 50% may be normalized to 1. In various embodiments, the normalized drift quantities may be utilized by drift administrator 210 to quantify drift of a component, such as using them as the constituent parts of risk calculations of non-compliance with ethos objectives. In many embodiments, the drift administrator 210 of EM system 202 may identify causes of drift by analyzing a multiplicity of risk calculations, such as by utilizing a multi-dimensional vector space, constructed using normalized drift quantities and used in conjunction with a machine learning model. In some embodiments, drift administrator 210 may determine drift projections for components and utilize them to anticipate upcoming issues and/or needs.

In many embodiments, the system manager 214 of EM system 202 may provide an improved user interface that allows users to intuitively utilize the capabilities of the EM system. For example, system manager 214 may operate in conjunction with ethos quantizer 206 to implement the guided user interface flow to determine the ethos for a client. More generally, system manager 214 may interoperate with various components of EM system 202 to provide the improved user interface. In another example, users may be able to cause the system to generate a graphical view of drift for a set of components. In yet another example, the system manager 214 may enable users to perform specific queries associated with drift, such as to assist in determining which laptops to replace. In yet another example, users may be able to adjust one or more configurations and/or settings of the system, such as by modifying ethos, target states, or weightings. Various embodiments may recommend and/or trigger remedial actions based on the client ethos, such as via remediation controller 212. In several embodiments, system manager 214 may track system activities, inputs, and outputs (e.g., by creating a log in datastores 204). These system activities, inputs, and outputs may be utilized by the performance improvement manager 216 to improve future system performance, such as through continuous learning. For example, the effect of a remedial action on the drift of a component may be determined and utilized to recommend additional remedial actions and/or adjust future remedial action recommendations. In another example, remedial action options may be presented for selection and the remedial action selected may be utilized to adjust future remedial action recommendations. Further, the datastores 204 may include one or more datastores utilized to support the functionalities of EM system 202.

In many embodiments, various techniques implemented by EM system 202 may utilize automation. Automation may refer to the programmatic performance of one or more tasks in response to a stimulus. In various embodiments, the EM system 202 may streamline and optimize routine tasks and workflows, minimizing manual effort and enhancing efficiency and accuracy across managed services and information technology operations. Automation can be broken down into a combination of stimulus, action, and result. A stimulus may refer to anything from user action (e.g., button click), scheduled action (e.g., patch distribution or backup), monitored values (e.g., form submission, CPU performance metrics, or virus detection), or programmatic action (e.g., API call). An action may refer to any set of steps that are performed to minimize what would otherwise be a manual effort. This may include things such as an API call which runs a single command, a script which runs one or more tasks, an automation policy (a file that calls one or more tasks programmatically), or other events. A result may refer to the measured outcome of the action. For example, the acknowledgement that a script or action has been taken, the acknowledgement that an action completed, or the measurement of a desired outcome (e.g., new CPU rate, new patch level, or boot image detection). In some embodiments, a result may be unmeasured.

In some embodiments, the EM system 202 may implement automation by calling one or more tasks in response to a stimulus (e.g., drift exceeding a threshold). In additional, or alternative, embodiments, the EM system 202 may flip the stimulus, action, result model on its head by making the action a byproduct of an exceptional result measurement. In other words, the result may correspond to a target state or happy state of a component, the stimulus may correspond to excessive drift of the component from the target state as determined based on monitoring, and the action may correspond to processes performed in response to the excessive drift to move the component back closer to the target state. More generally, this technique enables what it means for any component to be in a target state (e.g., an optimal or happy state) to be defined. For example, a laptop may be in a target state (the result sought) when it has up to date licenses, enough CPU and storage for their user to perform their actions on a daily basis, is free from viruses, has a recent backup, and is up to data on the latest patches. Continuing with the previous example, the EM system 202 may monitor the laptop component, determine if any of the attributes of the laptop are not aligned with the defined target state, and, if necessary, perform one or more action to realign the laptop with the defined target state.

To perform these techniques, and others described hereby, the EM system 202 may rely on data for each client system. This data, referred to as client system data, may be provided to or generated by the EM system 202. Further, this data may be stored in datastores 204. In many embodiments, datastores 204 may include a plurality of repositories in one or more locations for data utilized by the EM system 202. The client system data will be described in more detail with respect to FIG. 3. It will be appreciated that the client system data illustrated and described with respect to FIG. 3 may not be located in the same repository or datastore and they are illustrated together to simplify the description of the client system data. For example, a first portion may be located in an ethos datastore, a second portion may be located in a system datastore, and a third portion may be located in a workflow datastore.

FIG. 3 illustrates exemplary aspects of client system data 302 according to some embodiments. In the illustrated embodiment, client system data 302 includes system component set 304, relationships 318, priorities 320, ethos 322, target states 324, weights 326, drift sensitivities 328, sources 330, historical data 332, and other data 334. In various embodiments, client system data 302 may be created for each client system and/or portions of client systems, such as based on received data and data created by the EM system. This data may be utilized by the EM system to monitor and control the states of components in the system component set 304. It will be appreciated that one or more components of FIG. 3 may be the same or similar to one or more other components disclosed herein. Further, aspects discussed with respect to various components in FIG. 3 may be implemented by one or more other components from one or more other embodiments without departing from the scope of this disclosure. For example, various portions of the client system data 302 may be stored in a different one of datastores 204 without departing from the scope of this disclosure. Embodiments are not limited in this context.

The system component set 304 may include each component in a client system that's state is monitored and/or controlled by the EM system. In some embodiments, the system component set 304 may include a registry of components in the client system. The components in system component set 304 may include physical and non-physical components. In the illustrated embodiment, the system component set 304 include device set 306, services 308, objects 310, subsystems 312, users 314, and sentiments 316. Device set 306 may include physical devices, such as computers, smart phones, network switches, servers, routers, databases, and the like. Services 308 may include security, email, accessibility, throughput, performance, latency, information services, cloud services, business-to-business integration services, supply chain managed services, marketing services, media services, technical support services, and the like. Objects 310 may include data, files, and the like. Subsystems 312 may include various subsets of the client system, such as a backend, a front end, a storage subsystem, a registry, customer service subsystem, and the like. Users 314 may include various people associated with the client system, such as employees, contractors, managers, presidents, directors, programmers, engineers, individuals, and the like. Sentiments 316 may include various attitudes, feelings, and perceptions of one or more portions of the client or client system, such as client reputation or customer service satisfaction. In some embodiments, the blocks in system component set 304 may correspond to different types or classes of components. In some such embodiments, additional subtypes or subclasses of components may be included. For example, a type may include to computers and a first sub-type may include laptop computers, a second sub-type may include desktop computers, and each physical laptop may be indicated under the laptop computer subtype and each physical desktop may be indicated under the desktop computer subtype. In various embodiments, these different groupings may be utilized to identify corresponding templates, weightings, attributes, metrics, facts, and the like for various components.

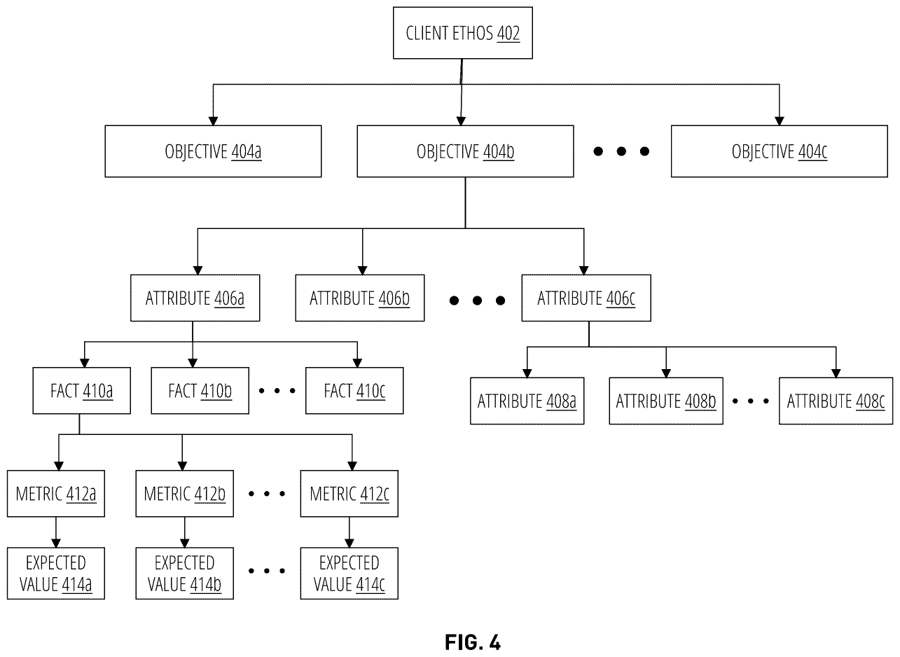

The relationships 318 may include various associations and dependencies between different components in the client system. For example, a printer may depend on a particular network router to function. The priorities 320 may include various client priorities, values, objectives, missions, goals, and the like. In some embodiments, priorities 320 may include data generated as part of a guided user interface flow to determine the ethos for a client. In one embodiment, priorities 320 may include various rankings of client objectives, facts, and metrics. As discussed in more detail below with respect to FIG. 4, ethos 322 includes a set of objectives for a client with each objective defined by a data structure comprising a hierarchical arrangement of attributes, facts, metrics, and expected values that transform the priorities 320 of a client into data usable by the EM system. In some embodiments, ethos 322 includes a plurality of ethos templates utilized to create an ethos for different clients.

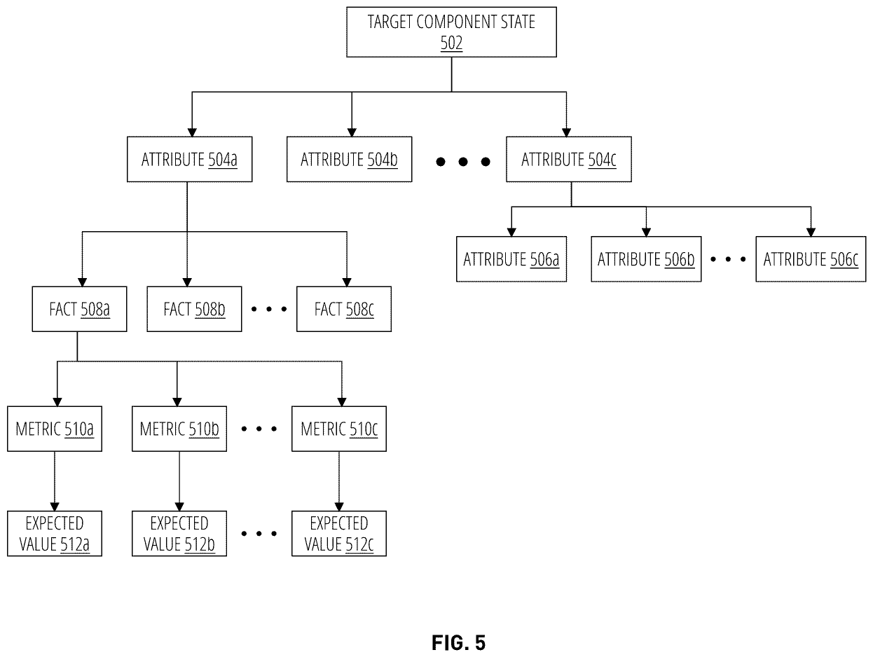

Similarly, as discussed in more detail below with respect to FIG. 5, target states 324 includes, for each component, group of components, or type of component, a hierarchical arrangement of attributes, facts, metrics, and expected values that define a happy state for each component, group of components, or type of component. In various embodiments, target states 324 may include various target state templates utilized to create target states for various components of a client system. For example, a first template may correspond to mobile devices, a second template may correspond to laptops, a third template may correspond to services, a fourth template may correspond to services, a fifth template may correspond to users, and a sixth template may correspond to sentiments. In some embodiments, target states 324 may include target state models or drift models.

The weights 326 may correspond to weightings utilized to ensure the ethos of a client is reflected in the output of the system. In some embodiments, weights 326 may be included in, or derived from, the target states 324 and/or ethos 322. For example, weights 326 may cause the EM system to prioritize an issue with a virus scanner for a laptop over an issue with memory space because the ethos of the client values system security over resource availability. Drift sensitivities 328 may correspond to various threshold levels that trigger further processing, such as remedial actions. In other words, drift sensitivities 328 may indicate how much drift from a target state is acceptable before additional action is taken. In various embodiments, drift sensitivities 328 may be determined for each attribute. Sources 330 may provide indications of where data to determine the state of each component may be obtained. For example, a first source may include the component itself (e.g., onboard diagnostics and sensors), a second source may include another component communicatively coupled to the component (e.g., a router that communicatively couples the component to the client system), and a third source may include a data repository (e.g., record of repairs performed on the component). The historical data 332 may include a record various activities, input, and outputs of the EM system. In various embodiments, historical data 332 may be utilized to perform continual learning. Other data 334 may include remedial actions, workflows, metadata, settings, configurations, and the like. For example, other data 334 may include remedial actions, workflows, and/or automation policies, such as for reducing the drift of a component.

FIG. 4 illustrates exemplary aspects of a client ethos 402 according to some embodiments. Generally, a client ethos may include a set of objectives for a client with each objective defined by a data structure comprising a hierarchical arrangement of attributes, facts, metrics, and expected values that transform the priorities, values, goals, etc. of a client into data usable by the EM system. Accordingly, the ethos of a client may be defined by the contents of the illustrated data structure. It will be appreciated that one or more components of FIG. 4 may be the same or similar to one or more other components disclosed herein. For example, client ethos 402 may be the same or similar to ethos 322. Further, aspects discussed with respect to various components in FIG. 4 may be implemented by one or more other components from one or more other embodiments without departing from the scope of this disclosure. Embodiments are not limited in this context.

Oftentimes MSPs are required to make important resource and service tradeoff decisions for their clients in order to maintain managed components as close as possible to a target state as practical. Thus, in order to effectively serve a client base an EM system needs to be able to make recommendations, determinations, and decisions on behalf of the client in a manner that aligns with the ethos of the client. These decisions can be as simple as which hardware should be acquired in the upcoming fiscal year, or as complex as which user is the least satisfied with their experience and who should be assigned to the next available support technician for assistance. These decisions, however, are subjective. In other words, different MSP clients have different views of what is important because of the numerous factors that go into determining what is important. For example, different clients, or portions thereof (e.g., divisions, locations, departments) have different definitions of what is good, happy, or right based on their different physical locations, cultures, tasks, missions, goals, values, and the like.

Accordingly, embodiments described hereby include a mechanism for viewing and ranking components and issues in an accurate and reliable manner that aligns with the ethos of the client. In several embodiments, client ethos 402 serves as a basis for this mechanism by quantizing the subjective priorities, values, goals, etc. of a client into data usable by the EM system. In other words, the client ethos 402 may be utilized to guide the EM system to make recommendations, determinations, and decisions that align with the objectives of a client (e.g., by applying weights). For example, the client ethos 402 may be utilized to inform default weighting of attributes within a target state and/or determine which remedial actions (e.g., automations) should occur when a component drifts too far from the target state. In various embodiments, the various objectives, attributes, facts, and metrics may be ranked with respect to each other. In various such embodiments, the rankings may be determined as part of the guided user interface flow for determining the ethos of a client. Accordingly, for example, the client ethos 402 may enable to EM system to determine how a client would rank their various objectives, such as sustainability versus security versus compliance versus usability.

In one example, when a laptop is detected with excessive drift, the root cause of the drift may be determined to be: (1) a CPU over 99% for four minutes that occurred three times in two days; (2) application crash that occurred two times in three days; (3) user ticket generation of high priority; and (4) laptop age of over five years exceeds low drift. These values may be determined based on monitoring and comparing to expected values. In response to these causes, the EM system may recommend (1) increase CPU on existing laptop and/or (2) acquire and deploy new laptop. In the case where the client ethos prioritizes customer satisfaction, the recommended remedial action may be to acquire a new laptop. However, in the case where the client ethos prioritizes sustainability, the recommended remedial action may be to increase the CPU because it generates a lower electronic waste footprint.

As shown in the illustrated embodiment, client ethos 402 includes one or more objectives 404a, 404b, 404c (collectively referred to as objectives 404) for a client. For example, a first objective may be sustainability, a second objective may be control, a third objective may be security, a fourth objective may be cost efficiency, and a fifth objective may be compliance. Each one of the objectives 404 may be defined by the hierarchical arrangement of attributes, facts, metric, and expected values. It will be appreciated that any number or arrangement of objectives, attributes, facts, metrics, and expected values may be utilized without departing from the scope of this disclosure. For example, an attribute (e.g., attribute 406c) may include sub-attributes (e.g., attributes 408a, 408b, 408c). In another example, a client ethos 402 may include over a thousand attributes, facts, metrics, and expected values. In yet another example, some attributes, facts, and metrics may appear in multiple places, such as under multiple objectives.

Referring back to FIG. 4, an exemplary data structure with the hierarchical arrangement is illustrated with respect to objective 404b. For example, objective 404b may be top quality customer service. A first level in the hierarchy includes one or more attributes 406a, 406b, 406c (collectively referred to as attributes 406). Attributes may include high level parameters of an objective. Continuing with the previous example, an attribute may be short time between customer service ticket creation and resolution. A second level in the hierarchy below attribute 406a includes one or more facts 410a, 410b, 410c (collectively referred to as facts 410). Facts may include a set of knowns in regard to the corresponding attribute. Continuing with the previous example, a first fact may be a time from customer service ticket creation to first client follow up. A third level in the hierarchy below fact 410a includes one or more metrics 412a, 412b, metrics 412c (collectively referred to as metrics 412). Metrics may refer to a way to validate a corresponding fact. Continuing with the previous example, a first metric may comprise a time between ticket creation and first follow up with the client. A fourth level in the hierarchy includes expected value 414a below metric 412a, expected value 414b below metric 412b, and expected value 414c below metric 412c. Continuing with the previous example, the expected value for the time between customer ticket creation and first follow up with the client may be 12 hours. During operation of the EM system, the previous example may manifest in the system prioritizing the allocation of additional resources to a customer triage bot of the client system over the allocation of additional resources to replacing an engineer's laptop.

FIG. 5 illustrates exemplary aspects of a target component state 502 according to some embodiments. Generally, a target component state 502 may include a data structure comprising a hierarchical arrangement of attributes, facts, metrics, and expected values that translate the priorities, values, goals, etc. of a client into an ideal state for various components monitored and/or controlled by the EM system. Accordingly, the target state of a component may be defined by the contents of the illustrated data structure. It will be appreciated that one or more components of FIG. 5 may be the same or similar to one or more other components disclosed herein. For example, target component state 502 may be the same or similar to target states 324. Further, aspects discussed with respect to various components in FIG. 5 may be implemented by one or more other components from one or more other embodiments without departing from the scope of this disclosure. Embodiments are not limited in this context.

As shown in the illustrated embodiment, target component state 502 includes a hierarchical arrangement of attributes, facts, metric, and expected values. It will be appreciated that any number or arrangement of attributes, facts, metrics, and expected values may be utilized without departing from the scope of this disclosure. For example, an attribute (e.g., attribute 504c) may include sub-attributes (e.g., attributes 506a, 506b, 506c). In another example, a target component state 502 may include over a thousand attributes, facts, metrics, and expected values. In several embodiments, one or more of the attributes, facts, and metrics may be weighted and/or ranked. These weightings and rankings may be based, at least in part, on the client ethos. In several embodiments, clients may provide and/or modify the weightings and rankings.

Referring back to FIG. 5, an exemplary data structure with the hierarchical arrangement is illustrated with respect to target component state 502. For example, target component state 502 may be a laptop. A first level in the hierarchy includes one or more attributes 504a, 504b, 504c (collectively referred to as attributes 504). Attributes may include high level parameters of an objective. Continuing with the previous example, the attributes 504 for the laptop may include licensing, hardware, software, operating system, patches, security, scanning, and backups. A second level in the hierarchy below attribute 504a includes one or more facts 508a, 508b, 508c (collectively referred to as facts 508). Facts may include a set of knowns in regard to the corresponding attribute. Continuing with the previous example, a first fact under the hardware attribute may be that the laptop is manufactured by AAA Computers and a second fact under the hardware attribute may be that the laptop has a solid state drive. In another example, a fact under the software attribute may be that the laptop has backup software installed. Additionally, or alternatively, this fact may be included under the backup attribute. In other words, some attributes, facts, and metrics may appear in multiple places.

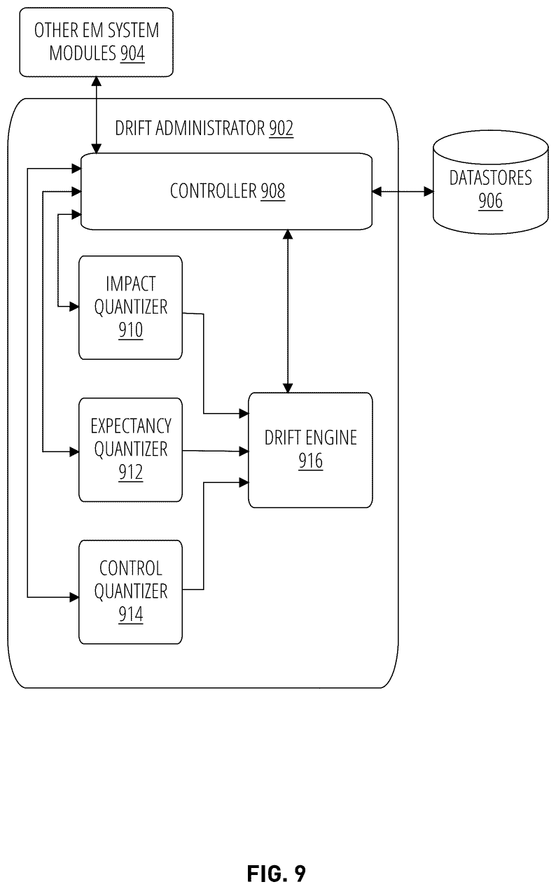

A third level in the hierarchy below fact 508a includes one or more metrics 510a, 510b, 510c (collectively referred to as metrics 510). Metrics may refer to a way to validate a corresponding fact. Continuing with the previous example, a first metric may comprise a registry key and a second metric may comprise a BIOS result. A fourth level in the hierarchy includes expected value 512a below metric 510a, expected value 512b below metric 510b, and expected value 512c below metric 510c. Continuing with the previous example, the expected value for the registry key may include the portion and contents of the registry key that identifies the manufacturer of the component as AAA computers. Additionally, in many embodiments, timestamps may be validated in conjunction with expected values. For example, the system manager may generate timestamps each time a value for a metric is determined and the timestamp may be validated as being produced in a predefined period of time. In various embodiments described hereby, the difference in a metric value determined during monitoring of a component and the expected value for the metric may be compared to determine drift of the component. Further, the difference between the expected value and a measured value may be scaled up or down using weightings in a manner to implement the ethos of a client. The determination of component drift is discussed in more detail below, such as with respect to FIG. 9.

In various embodiments, the highest level goal of a target state is to ensure that client systems are maintained in a state that aligns with the client and user priorities. However, as previously mentioned, a target state isn't a one size fits all, thus a flexible way for defining target states for a wide variety of scenarios and components is utilized. This flexible way may be manifested, at least in part, by utilizing different models or templates to determine a target state. For example, one or more of a fault, configuration, accounting, performance, security (FCAPS) model, a user experience (UX) model, a service quality (SERVQUAL) model, and an infrastructure maturity model may be utilized, each of which provide unique perspectives on what constitutes a target state. In various embodiments, different models may be utilized for different types of components. In some embodiments, these models may be applied to client ethos additionally or alternatively.

In an FCAPS model, the following objectives/parameters may be utilized. Fault-detect and address faults in systems or services promptly. Configuration-ensure configurations are optimal and standardized. Accounting-monitor and manage system usage and resource allocation effectively. Performance-maintain systems performing at the expected or enhanced levels. Security-ensure all systems and data are secure from internal and external threats.

In a UX model, the following objectives/parameters may be utilized. Usability-evaluate how intuitive and user-friendly the system are. Accessibility-measure how accessible services are for all users including those with disabilities. Satisfaction-assess user satisfaction through surveys and feedback mechanisms. Efficiency-determine how effectively users can complete their tasks using the systems.

In a SERVQUAL model, the following objectives/parameters may be utilized. Tangibles-physical facilities, equipment, and appearance of personnel. Reliability-ability to perform the promised service dependably and accurately. Responsiveness-willingness to help customers and provide prompt service. Assurance-knowledge and courtesy of employees and their ability to inspire trust and confidence. Empathy-caring, individualized attention provided to clients.

In an infrastructure maturity model, the following objectives/parameters may be utilized. Standardization—the degree to which infrastructure components are standardized and efficiently managed. Consolidation—the extent to which resources are centrally managed and optimized. Virtualization—the degree of virtualization and dynamic resource allocation. Automation—the level of automation in managing routine and complex tasks. Service alignment—the alignment of services with business goals and outcomes.

Accordingly, the target component state 502 can be utilized in a variety of scenarios and with a variety of components to define a happy or target state. In some embodiments, an instance of the target component state 502 may correspond to user device performance and be utilized to ensure devices operate within optimal performance parameters, with attributes like speed, responsiveness, and uptime prioritized. In various embodiments, an instance of the target component state 502 may correspond to software usability for measuring user satisfaction with the usability of critical software applications, focusing on ease of use, feature accessibility, and user interface design. In several embodiments, an instance of the target component state 502 may correspond to security posture for confirming all security measures are active and updated.

In many embodiments, an instance of the target component state 502 may correspond to ransomware readiness status for verifying backups are completed successfully and data integrity is maintained. In some embodiments, an instance of the target component state 502 may correspond to patch management for ensuring systems are up-to-date with the latest patches applied. In various embodiments, an instance of the target component state 502 may correspond to network performance for monitoring network latency and throughput to maintain optimal performance. In many embodiments, an instance of the target component state 502 may correspond to application performance for ensuring critical applications operate within expected performance thresholds. In several embodiments, an instance of the target component state 502 may correspond to storage utilization for monitoring disk space to prevent capacity issues.

In some embodiments, an instance of the target component state 502 may correspond to hardware lifecycle for tracking and managing the lifecycle status of hardware components. In various embodiments, an instance of the target component state 502 may correspond to license compliance for ensuring all software licenses are valid and compliant. In several embodiments, an instance of the target component state 502 may correspond to endpoint protection for verifying that antivirus and anti-malware solutions are active and up-to-date. In many embodiments, an instance of the target component state 502 may correspond to user account management for ensuring user accounts are managed according to security policies. In some embodiments, an instance of the target component state 502 may correspond to data privacy compliance for confirming adherence to data protection regulations (e.g., GDPR and HIPAA). In various embodiments, an instance of the target component state 502 may correspond to cloud resource utilization for monitoring and optimizing cloud service usage and costs.

In several embodiments, an instance of the target component state 502 may correspond to VPN connectivity for ensuring reliable and secure VPN connections for remote work. In many embodiments, an instance of the target component state 502 may correspond to mobile device management for monitoring the health and security of mobile devices. In some embodiments, an instance of the target component state 502 may correspond to disaster recovery readiness for verifying disaster recovery plans are in place and functional. In various embodiments, an instance of the target component state 502 may correspond to incident response times for monitoring and improving response times to incidents and issues. In several embodiments, an instance of the target component state 502 may correspond to customer support satisfaction for tracking customer satisfaction with support services.

In various embodiments, an instance of the target component state 502 may correspond to service level agreement (SLA) compliance for ensuring services met or exceed agreed-upon SLAs. In some embodiments, an instance of the target component state 502 may correspond to power management for ensuring power supply stability and efficiency. In many embodiments, an instance of the target component state 502 may correspond to software deployment success for verifying successful deployment of software and updates. In several embodiments, an instance of the target component state 502 may correspond to network connectivity for ensuring stable and fast network connections (e.g., internet connection). In various embodiments, an instance of the target component state 502 may correspond to print services for ensuring printers and print services are operational and efficient. In some embodiments, an instance of the target component state 502 may correspond to asset inventor accuracy for maintaining accurate and up-to-date asset inventories (e.g., IT asset inventories). In many embodiments, an instance of the target component state 502 may correspond to firewall performance for monitoring and managing firewall performance and rules. In several embodiments, an instance of the target component state 502 may correspond to change management efficiency for monitoring the effectiveness and impact of change in management processes. In various embodiments, an instance of the target component state 502 may correspond to energy efficiency for monitoring and optimizing energy usage.

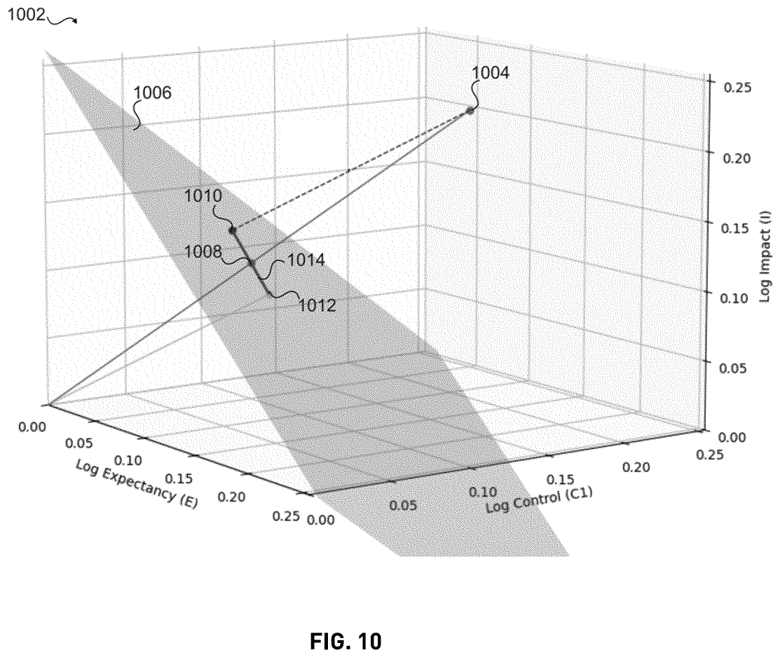

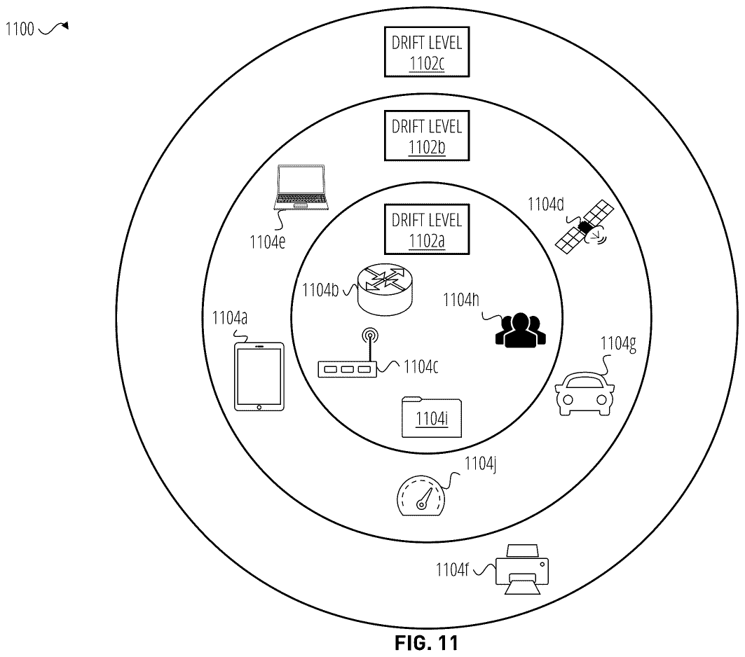

Accordingly, in various embodiments, the EM systems disclosed hereby and the modules thereof may perform or implement one or more of the following. Utilize ethos as a mechanism for weighing priority and action decision making for management in client systems (e.g., enterprise IT and MSP environments). Further, attributes, facts, values, and expected values may be utilized as a weighted mechanism for determining ethos. In various embodiments, ethos may be an automated input utilized to created weighting in drift models. In various such embodiments, the ethos may be utilized to automatically determine the weighting that happens when drift is calculated for a component. For example, if a client ethos has the highest priority of security (e.g., the latest and greatest regardless of user experience), the EM system would weigh the dimensions of patch level on any application as the highest value. The outcome of this would be identification of a component as having the highest level of drift regardless of other aspects of the component, thereby enabling prioritization of action on the security-challenged component. In many embodiments, automation of action against the outputs of drift models may be based on a distance from the centroid as an indicator of need (see e.g., FIG. 10). Further, remedial actions may be prioritized based on the client ethos. In some embodiments, drift distance may be reconfigured against any component or template by rearranging or changing ethos priorities or definitions. In several embodiments, a learning mechanism may be utilized to improve target state templates and/or definitions, such as through monitoring and recording of user actions against components, such as those displayed in FIG. 11). In various embodiments, the creation of target states may utilize a combination of predefined client ethos and a scan of a known component in a target state.

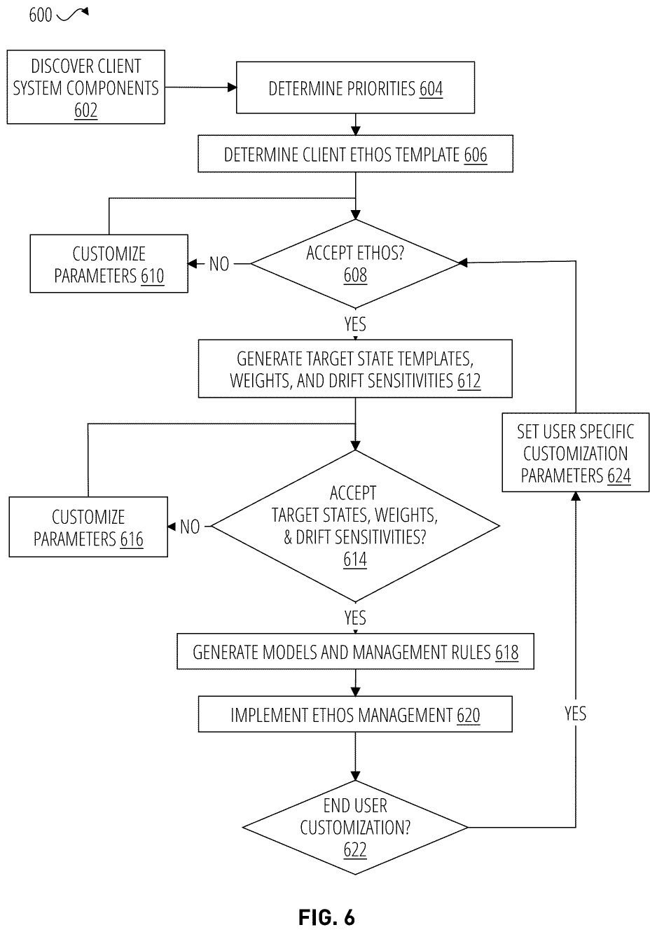

FIG. 6 illustrates an exemplary process flow 600 for setting up an EM system according to some embodiments. In various embodiments, the process flow 600 occurs as part of a guided user interface flow to determine the ethos for a client. The process flow 600 is performed by processing logic that may comprise hardware (circuitry, dedicated logic, etc.), software (such as is run on a general purpose computer system or a dedicated machine), firmware, or a combination. In various embodiments, the process flow 600 is performed by one or more of a distributed services system (e.g., distributed services system 104), a server system (e.g., server computer system 110), and an EM system (e.g., EM system 112 or EM system 202). Embodiments are not limited in this context.

Referring to FIG. 6, the process flow 600 begins at block 602. At block 602, client system components may be discovered. For example, components in a client system that are to be monitored and/or controlled by the EM system 202 may be identified by the ethos quantizer 206. In some embodiments, the discovery process may be automatic or semi-automatic, such as by searching an intranet for components having specific characteristics associated with the client. In various embodiments, a client may provide a list of components.

Proceeding to block 604, priorities may be determined for the client. For example, ethos quantizer 206 may utilize a guided user interface flow for defining client ethos that solicits input from a client to rank, prioritize, and/or describe values, missions, goals, objectives, and the like of the client. At block 606, a client ethos template may be determined, such as based on the client system components and determined priorities. For example, ethos quantizer 206 may identify and retrieve an ethos template based on the data determined as part of the guided user interface flow to define their ethos. Further, at least a portion of the contents of the ethos template may be added or modified based on the data determined as part of the guided user interface flow to define ethos. At decision block 608, it may be determined whether the client accepts the ethos. If the client does not accept the ethos, then the process flow 600 may proceed to block 610, where the client may customize one or more parameters of their ethos and then return to decision block 608.

If the ethos is accepted, then the process flow 600 may proceed to block 612. At block 612, target state templates, weights, and drift sensitivities may be generated. For example, datastores ethos quantizer 206 may generate target states 324, weights 326, and drift sensitivities 328 based on the client ethos and the set of components. Continuing to decision block 614, it may be determined whether the client accepts the target states, weights, and drift sensitivities. If the client does not accept the target state templates, weights, and drift sensitivities, the process flow 600 may proceed to block 616, wherein the client may customize one or more parameters of the target's states, weights, and drift sensitivities.

If the target states, weights, and drift sensitivities are accepted, the process flow 600 may proceed to block 618. At block 618, various models and management rules may be generated based on the client ethos, targets states, weights, and drift sensitivities. For example, ethos quantizer 206 may generate an ethos model, a plurality of target state models, and various thresholds based on the client ethos, target states, weights, and/or drift sensitivities. At block 620, ethos management may be implemented. For example, EM system 202 may be activated to monitor and control components of the client system. Proceeding to decision block 622, it may be determined whether to perform end user customizations. End user customization may refer to modifications to the ethos, target state, weights, target sensitivities, and/or management rules for various subsets of client system components. For example, once ethos management has been implemented, the first time a user logs into their device, they may be given options to modify the ethos, target states, weights, and drift sensitivities. In various embodiments, the available options may be based on a seniority level of the user or component. For example, all options may be available to a president while few or no options may be available to a receptionist. If end user customization is not performed, process flow 600 may end. If end user customization is performed, process flow 600 may return to decision block 608 after user specific customization parameters are set in block 624.

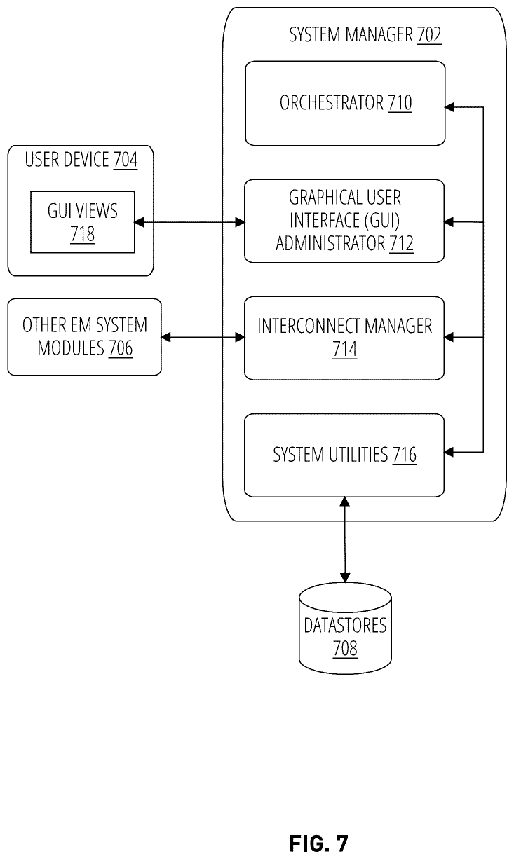

FIG. 7 illustrates various aspects of a system manager 702 according to some embodiments. In the illustrated embodiment, system manager 702 is communicatively coupled to a user device 704, other EM system modules 706, and one or more datastores 708. In various embodiments, the system manager 702 may generally direct and coordinate operation of the EM system as well as provide various system functionalities. The system manager 702 includes an orchestrator 710, a GUI administrator 712, an interconnect manager 714, and system utilities 716. It will be appreciated that one or more components of FIG. 7 may be the same or similar to one or more other components disclosed herein. For example, system manager 702 may be the same or similar to system manager 214. Further, aspects discussed with respect to various components in FIG. 7 may be implemented by one or more other components from one or more other embodiments without departing from the scope of this disclosure. For example, system manager 702 may access datastores 708 via the one or more of other EM system modules 706 (e.g., system manager 214). Embodiments are not limited in this context.

The system manager 702 may provide numerous functionalities to an EM system that support various techniques described hereby. For example, the system manager 702 may orchestrate techniques by coordinating operation of various other EM system modules 706, provide interface mechanisms for interacting with users, tracking system activities, inputs, and outputs, and/or provide data storage and retrieval services. In various embodiments, the GUI administrator 712 may be responsible for interfacing with users of the EM system. For example, GUI administrator 712 may cause user device 704 to generate a GUI and display various GUI views 718.

In several embodiments, the orchestrator 710 may be responsible for coordinating various functionalities of the EM system. For example, orchestrator 710 may request that the drift administrator (e.g., via interconnect manager 714) determine a current drift for a component in response to input received from user device 704 via GUI administrator 712. In another example, orchestrator 710 may coordinate the storage of data generated as part of the guided user flow to determine ethos. In some such example, the orchestrator 710 may be responsible for storing various ethos models, state models, drift models, and the like in the appropriate data stores to facilitate operations of the EM system. In some embodiments, the interconnect manager 714 may be responsible for communication between other EM system modules 706. For example, a state monitor may communicate with a drift administrator via interconnect manager 714. In another example, a performance improvement manager may communicate with a drift administrator via interconnect manager 714. In other embodiments, different modules may directly communicate with each other. The system utilities 716 may provide various system services, such as by tracking system activities, inputs, and outputs, providing data storage and retrieval services, and the like. In one embodiment, the system utilities 716 may include an ingestion engine for generating records based on user feedback, monitoring values, and/or generation of service tickets.

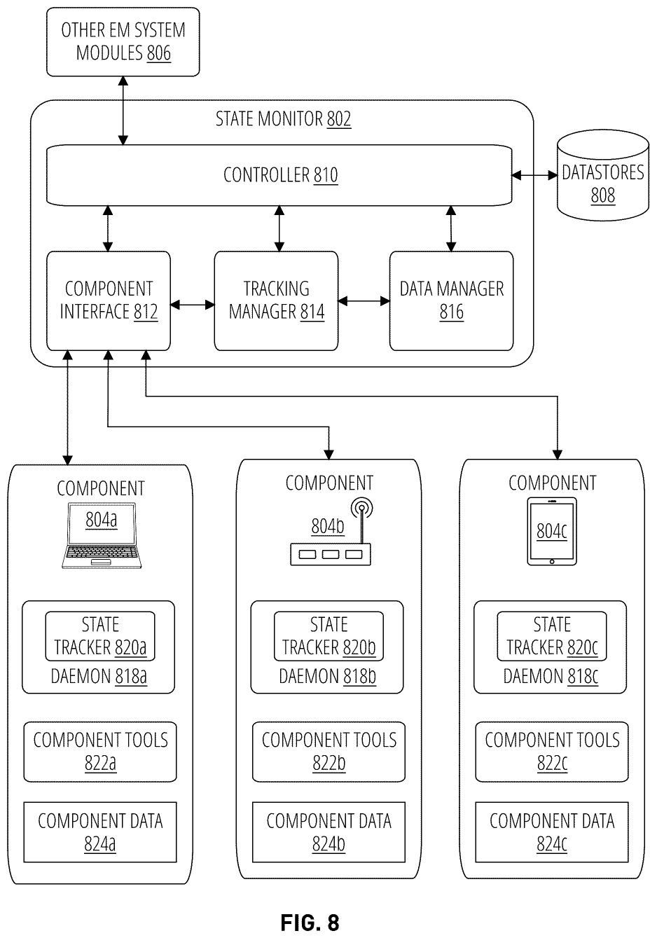

FIG. 8 illustrates various aspects of a state monitor 802 according to some embodiments. In the illustrated embodiment, state monitor 802 is communicatively coupled to components 804a, 804b, 804c (collectively referred to as components 804), other EM system modules 806, and one or more datastores 808. In various embodiments, the state monitor 802 may generally monitor and determine the state of components in a client system. The state monitor 802 includes a controller 810, a component interface 812, a tracking manager 814, and a data manager 816. It will be appreciated that one or more components of FIG. 8 may be the same or similar to one or more other components disclosed herein. For example, state monitor 802 may be the same or similar to state monitor 208. Further, aspects discussed with respect to various components in FIG. 8 may be implemented by one or more other components from one or more other embodiments without departing from the scope of this disclosure. For example, state monitor 802 may access datastores 808 via the one or more of other EM system modules 806 (e.g., system manager 214). Embodiments are not limited in this context.

The tracking manager 814 may be responsible for obtaining monitoring data from the components 804. In various embodiments, the tracking manager 814 may implement monitoring on the components 804. For example, tracking manager 814 may cause the components to install daemons 818a, 818b, 818c (collectively referred to as daemons 818). Additionally, tracking manager 814 may be responsible for monitoring that the daemons are properly functioning and/or keeping them up-to-date. Each of the daemons 818 may include a state tracker 820a, 820b, 820c (collectively referred to as state trackers 820). The state trackers 820 may interface with various component tools 822a, 822b, 822c and various component data 824a, 824b, 824c to obtain monitoring information from components 804. In some embodiments, the tracking manager 814 may be responsible for causing the components 804 to perform remedial actions. Further, the tracking manager 814 may be responsible for determining the effects/results of a remedial action.

The data manager 816 may be responsible for filtering data received from the components 804 and formatting it for storage in one or more of datastores 808. For example, data manager 816 may translate monitoring data received from a component into one or more formats utilized by other EM system modules 806. In a further example, the tracking manager 814 may translate tracking data received from a component into the proper format for updating a current state of a component. The controller 810 may be responsible for coordinating the operation of state monitor 802 and well as communicating with other EM system modules 806 and/or datastores 808. For example, controller 810 may provide instructions to tracking manager 814 based on a request to update drift values for a set of components. In some such examples, the requests could come from the system manager based on input received via a GUI and/or in response to a periodic current state update. In some embodiments, the controller 810 may cause the tracking manager 814 to update the state of system components periodically, such as every minute, hourly, daily, weekly, or monthly. Further, the state of different components in a client system may be updated at different frequencies. In various embodiments, the frequency of update may be based on client ethos. For example, if security is important to a client, then components associated with security functions (e.g., firewalls) may be monitored more frequently than components not associated with security functions (e.g., a printer). In another example, the importance of a user associated with a component or the number of other components that depend on a component may be utilized to determine the frequency with which a component is monitored. These considerations equally apply to drift determinations. In some embodiments, drift determinations may be automatically performed in response to updated state determinations. In other embodiments, performance of drift determinations may trigger updates to component states. The component interface 812 may provide interface functionality for the state monitor 802 to communicate with the components 804 for monitoring the components.

FIG. 9 illustrates various aspects of a drift administrator 902 according to some embodiments. In the illustrated embodiment, drift administrator 902 is communicatively coupled to other EM system modules 904 and one or more datastores 906. In various embodiments, the drift administrator 902 may generally be responsible for determining drift and projected drift from components based on their target state and their current state. It will be appreciated that one or more components of FIG. 9 may be the same or similar to one or more other components disclosed herein. For example, drift administrator 902 may be the same or similar to drift administrator 210. Further, aspects discussed with respect to various components in FIG. 9 may be implemented by one or more other components from one or more other embodiments without departing from the scope of this disclosure. For example, drift administrator 902 may access datastores 906 via the one or more of other EM system modules 904 (e.g., system manager 214). Embodiments are not limited in this context.

The controller 908 may coordinate operations of the drift administrator 902. For example, the controller 908 may obtain the required state, ethos, and component data to determine the drift for a component. Further, the controller 908 may utilize the data to generate the appropriate inputs for impact quantizer 910, expectancy quantizer 912, and control quantizer 914. In some such examples, drift determination updates may occur in response to a request from other EM system modules 904 or periodically, such as every minute, hourly, daily, weekly, or monthly. In various embodiments, the frequency of update may be based on client ethos, as discussed above.

The impact quantizer 910, expectancy quantizer 912, and control quantizer 914 may generate impact, expectancy, and control values that are provided to the drift engine 916 to calculate drift values as explained in more detail below. In various embodiments, drift may be analogous to or correlated with risk. For example, increasing drift indicates an increased risk of a negative outcome in view of a client ethos.

Calculating the drift associated with a component (e.g., a business process, system, or other asset) may be based on a summation of a set of scenario-specific deviations of risk from their nominal threshold parameters. Based on the identification of(s) risk scenarios associated with a components drift (D), with corresponding calculated risk values (Rᵢ) and nominal threshold (Rᵢ^{N}) parameters, their relationship can be defined as shown in Equation 1 below

$$D = {\sum }_{i = 1}^{s} \vert {R}_{i} - {R}_{i}^{N} \vert \qquad Equation 1$$

Calculating the risk associated with a scenario may be based around values for impact (I), expectancy (E), control (C), and implicit risk (R^{I}). In some scenarios, an attribute being measured may be risk (e.g., security risk associated with user permissions). However, in many scenarios, like the one above, the fact of a permission setting may be only one aspect of the drift. In such scenarios, the scope of impact is considered for proper measurement of drift (e.g., by extending the calculation to include values of impact, expectancy, and control. In various embodiments described hereby, the values for impact, expectancy, control, and implicit risk may be normalized between 0 and 1. Impact may quantify how bad an outcome will be. For example, with a data breach, how much information might be exposed would be quantified by the impact. In another example, with stolen capital, the potential amount of money that could be lost would be quantified by the impact.

Expectancy may quantify a probability representing a likelihood the outcome happens. In various embodiments, a value of zero may indicate the outcome is impossible, a value of one may indicate the outcome will occur with complete certainty, and a value of 0.5 may indicate there is a 50/50 chance the outcome will occur. Implicit risk may quantify risks that are not immediately identifiable or recognized. Control may quantify the reduction in impact, expectancy, and/or implicit risk due to controls (e.g., security controls, peer review, etc.). In some embodiments, a value of zero indicates perfect risk control and a value of one indicates complete ineffectiveness of control.

In the description below, based on the impact (I), expectancy (E), control (C), and implicit risk factor (R′^{I}), the risk (R) associated with a risk scenario can be defined as shown in Equation 2 below. The implicit risk factor (R′^{I}) has been derived from the additive implicit risk (R^{I}) through elementary algebraic manipulation.

$$R = I \times E \times C \times {R}^{′I} \qquad Equation 2$$

When modelling risk, control may be further expanded into a set of (c) contributing factors (Cᵢ) associated with each scenario-specific control (e.g. firewalls, access control systems, etc.) contributing a mitigating effect to the model. A more detailed risk equation may be defined as Equation 3 below.

$$R = I \times E \times {\prod }_{i = 1}^{c} {C}_{i} \times {R}^{′I} \qquad Equation 3$$

Equation 3 can be used to approximate risk in scenarios where its user is attempting to proactively mitigate risk. This concept will be explained through use of an example. If the risk of a data breach due to a cyber-attack is being modelled, it is impossible to gauge its actual expectancy and the amount of exposed information. It could be more or less, so the worst may be assumed by maximizing the implicit risk (R′^{I}) which, in the context of the model, can be achieved by setting it to one. Taking this information into account, the risk equation can be simplified for approximations as shown in Equation 4 below.

$$R = I \times E \times {\prod }_{i = 1}^{c} {C}_{i} \qquad Equation 4$$

Equation 3 can be further simplified through linearization, as shown in equation 5 below. In one embodiment, an invertible transform x^{t}=log₂ (x+1) can be used to map impact, expectancy, control, and implicit risk factors on a logarithmic scale within the range of zero and one. This transformation is used to avoid the singularity of the logarithmic function at zero and for reducing rounding errors during numerical calculations.

$${R}^{t} = {I}^{t} + {E}^{t} + [ {\sum }_{i = 1}^{c} {C}_{i}^{t} ] + {R}^{{′I}^{t}} \qquad Equation 5$$

In various embodiments, equation 5 may be used to vectorize the risk equations by selecting a suitable set of basis vectors (êᵢ) with cardinality k, as shown in equation 6. The resultant vectors, defined in terms of these basis vectors, can then be analyzed using propositional or feature-based AI algorithms that operate on fixed length vectors. For example, vectorized risk measurements can be classified using machine learning algorithms like support vector machines (SVM) and/or K-nearest neighbors (KNN). In other examples, some neural networks can be applied to groups of vectorized risk measurements to identify complex non-linear relationships between them. In other embodiments, techniques for dimensionality reduction like principal components analysis (PCA) and/or generalized discriminant analysis (GDA) can be used to increase computational efficiency and model performance in large systems.

$$\hat{R} = [ {\sum }_{i = 1}^{c} {C}_{i}^{t} {\hat{e}}_{i} ] + {E}^{t} {\hat{e}}_{k - 2} + {R}^{{′I}^{t}} {\hat{e}}_{k - 1} + {I}^{t} {\hat{e}}_{k} \qquad Equation 6$$

In various embodiments, a k-dimensional affine subspace may be used to map vectors of the form given in Equation 6 to hyperplanes (or level sets) coinciding with regions of constant risk |\hat{n}· [symbol] |, where [symbol] is a model parameter called its support point. A general equation for affine subspaces is shown in equation 7 below. This well-established property of affine subspaces, i.e. \hat{n}·\hat{R}=\hat{n}· [symbol] , can be used by embodiments to perform advanced risk analysis by utilizing the algebraic properties of affine subspaces, for example the intersection of rays and projection of points on to these hyperplanes. These embodiments may also utilize the property that risk [symbol] is one-dimensional in the direction of the hyperplanes normal (\hat{n}).

$$\hat{R} = \text{?} + [ {\sum }_{i = 1}^{c} {C}_{i}^{t} {\hat{e}}_{i} ] + {E}^{t} {\hat{e}}_{k - 2} + {R}^{{′I}^{t}} {\hat{e}}_{k - 1} + {I}^{t} {\hat{e}}_{k}$$

An affine subspace model encapsulating k pair-wise relationships between impact (I) and the remaining k−1 values Vᵢ (i.e. expectancy, implicit risk, and controls) can be employed, as shown in Equation 8 below. In this exemplary model, the components of all vectors R coinciding with its hyperplane equate to the risk threshold parameter r₀ under application of Equation 5. Additionally, the imposed linear relationships

$${I}^{t} = {r}_{0}^{t} - {V}_{i}^{t}$$

orders the elements within the affine subspace so that vector analysis techniques (e.g. dot products, cosine similarities, etc.) may be used with risk scenario measurement vectors R to infer additional information about the component ratios of I and Vᵢ preserved by the logarithmic transform. For example, consider a risk vector containing six control measurement all equal to 0.9. In a real-world scenario this would lead to a mitigating factor of 0.47 from a risk calculation, which may seem reasonable on paper, but is effectually a false positive because the controls are really inefficient. However, under the model parameterization in Equation 8, the inefficiencies can be quickly identified by a single operation. In various embodiments, the linear relationships introduced by the basis vectors may implement complex forms of component ratio-preserving relationships between impact, expectancy, control, and implicit risk values.

$$\text{?} = [ \begin{matrix}1 \\ 0 \\ 0 \\ ⋮ \\ 0 \\ - 1\end{matrix} ] , [ \begin{matrix}0 \\ 1 \\ 0 \\ ⋮ \\ 0 \\ - 1\end{matrix} ] , [ \begin{matrix}0 \\ 0 \\ 1 \\ ⋮ \\ 0 \\ - 1\end{matrix} ] , … , [ \begin{matrix}0 \\ 0 \\ 0 \\ ⋮ \\ 1 \\ - 1\end{matrix} ] \qquad Equation 8$$

$$\begin{matrix}\hat{n} = [ \begin{matrix}1 \\ 1 \\ 1 \\ ⋮ \\ 1\end{matrix} ] & \text{?} = [ \begin{matrix}0 \\ 0 \\ 0 \\ ⋮ \\ {r}_{0}^{t}\end{matrix} ]\end{matrix} .$$

In some embodiments, a simpler determination of drift may be utilized, such as for components with fewer drift influencing parameters. In various embodiments, one such technique may utilize a mathematical model that generates a drift value by summing up each attribute multiplied by a weight. For example, drift may be calculated as the target state minus the sum of the current state multiplied by the weighting (e.g., an array of attributes * weighting). Using such a technique, for example, a perfect laptop would have a score of zero—meaning a distance of zero from the target state. A near-drift laptop may have a score of 0.5—meaning a small distance from the target state. A high-drift laptop may have a relative score of one—meaning a massive distance from the target state. The preceding technique is an exemplary option for utilization in drift measurements for non-concrete determinations (e.g., not based on a fact that is true or false, such as a setting).

FIG. 10 illustrates exemplary aspects of a state or vector space in a plot 1002 according to some embodiments. The plot 1002 may be generated based on the equations and relationships described with respect to FIG. 9. In the illustrated embodiment, the vector space includes a first dimension corresponding to control (C), a second dimension corresponding to expectancy (E), and a third dimension corresponding to impact (I). Accordingly, the equations described above may be utilized to calculate these values for various client components. Further, an acceptable risk plane 1006 is illustrated. The acceptable risk plane 1006 may correspond to acceptable drift and indicate the threshold for triggering further actions to resolve component drift. The current component state embedding 1004 may correspond to the current state of a component for which drift is being determined. The test measurement projection 1010 may be a point projected onto the acceptable risk plane 1006 from the current component state embedding 1004. The difference between the inverse transforms of the test measurement projection 1010 and the current component state embedding 1004 may correspond to the risk deviation or drift of the component. The test measurement intersection 1008 indicates the point on the acceptable risk plane that has the same pair-wise impact/value component ratio as the current component state embedding 1004. The test measurement projection 1010 and the test measurement intersection 1008 and/or the normal intersection 1012 can be utilized to determine the basis posture, which measures the individual inefficiency of the non-impact values, and the location delta 1014, which facilitates measurement of the overall impact posture. In various embodiments, the basis and impact postures may influence the overall risk score according to a mathematical model or embedded system logic.

The point (log 2) location may refer to the transformed impact, expectancy, and control components associated with the current component state embedding 1004. The risk target distribution may refer to the difference in component ratio between the projected and the transformed point location. The risk target distribution may refer to the optimal risk component ratio. The intersection may refer to the intersection between the line connecting the test point to the origin and the acceptance plane. The normal intersection may refer to the intersection between the line connecting the normal to the origin and the acceptance plane. The basis posture may refer to the similarity between the projection/intersection delta (vector) and each of the basis vectors, and the impact posture may refer to the similarity between the projection/intersection delta (vector) and the affine subspace support/normal intersection delta (vector). Each similarity may be a point between −1 and 1, where zero means completely different, one means identical, and negative one means identical but pointing in opposite direction. Further, plot 1002 may illustrate the values shown in Table 1 below.

TABLE 1

| Point analysis for: | Test Measurement |
|---|---|
| Point (log2) location: | [0.13838562 0.18451416 0.21911057] |
| Risk: | 0.45599999999999996 |
| Risk components: | [0.6 0.8 0.95] |
| Risk threshold: | 0.2 |
| Risk threshold delta: | 0.25599999999999995 |
| Risk target: | 0.2 |
| Risk target distribution: | [0.45586855 0.60782474 0.72179188] |
| Risk target distribution delta: | [−0.14413145 −0.19217526 −0.22820812] |
| Impact posture: | −0.04707974490670878 |
| Basis posture: | [−0.05708116 −0.02446335] |

In some embodiments, in the event of drift, a smart targeted action generator (STAG) pattern can analyze all aggregated data related to the drift event and determine correlated actions and plausible overlapping metadata. STAG may refer to an intelligent framework designed to identify, analyze, and recommend corrective actions in response to observations including drift events. In some embodiments, this may be used to trigger proactive more-sensitive drift detection or determine new patterns to monitor for to prevent future drift.

FIG. 11 illustrates an exemplary drift GUI view 1100 according to some embodiments. FIG. 11 illustrates an improved user interface for enabling visualization of component drift in an intuitive and useful manner. When combined with other functionalities described hereby, the improved user interface facilitates navigating and evaluating complex interactions with a multitude of components of various formats in an intuitive and efficient manner using techniques unique to computers, such as interactive GUIs. For example, the positions of the components 1104 in drift GUI view 1100 may be based on the outputs of drift administrator 210 or drift administrator 902. It will be appreciated that one or more components of FIG. 11 may be the same or similar to one or more other components disclosed herein. For example, components 1104 may correspond to components 804 and/or system component set 304. In another example, drift GUI view 1100 may be the same or similar to one or more of GUI views 718. Further, aspects discussed with respect to various components in FIG. 11 may be implemented by one or more other components from one or more other embodiments without departing from the scope of this disclosure. For example, drift administrator 902 may access datastores 906 via the one or more of other EM system modules 904 (e.g., system manager 214). Embodiments are not limited in this context.

In the illustrated embodiment, numerous components 1104a (e.g., a tablet), 1104b (e.g., a network switch), 1104c (e.g., a router), 1104d (e.g., a satellite), 1104e (e.g., a laptop), 1104f (e.g., a printer), 1104g (e.g., a vehicle), 1104h (e.g., a persons or set of people), 1104i (e.g., a file or data), 1104j (e.g., a sentiment). These components may collectively be referred to as components 1104 and are displayed on top of concentric rings corresponding to drift levels 1102a, 1102b, 1102c with drift level 1102a corresponding to low drift, drift level 1102b corresponding to moderate drift, and drift level 1102c corresponding to high drift. In some embodiments, the different drift levels may correspond to drift thresholds. For example, remedial actions may be triggered for any components (e.g., component 1104f) included in drift level 1102c.

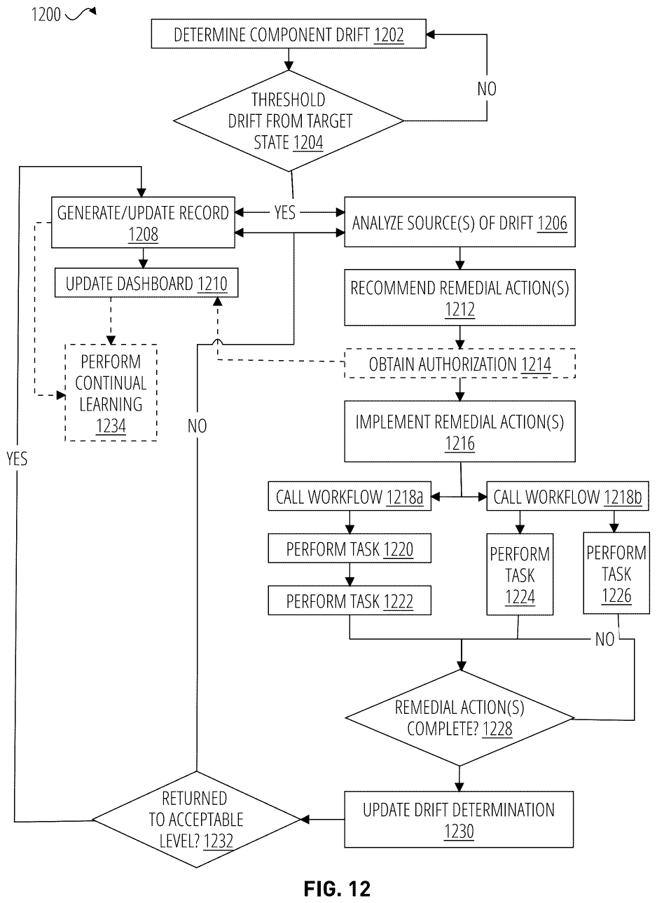

FIG. 12 illustrates an exemplary process flow 1200 for monitoring and controlling component state based on drift according to some embodiments. In various embodiments, the process flow 1200 occurs as part of monitoring and controlling the states of components in a client system. The process flow 1200 is performed by processing logic that may comprise hardware (circuitry, dedicated logic, etc.), software (such as is run on a general purpose computer system or a dedicated machine), firmware, or a combination. In various embodiments, the process flow 1200 is performed by one or more of a distributed services system (e.g., distributed services system 104), a server system (e.g., server computer system 110), an EM system (e.g., EM system 112 or EM system 202), and a client system (e.g., client systems 108 or components 114). Embodiments are not limited in this context.

Referring to FIG. 12, the process flow 1200 begins at block 1202. At block 1202, drift for a component in a client system may be determined. For example, drift administrator 902 may determine the drift for a component in a client system based on the ethos of the client and the current state of the components (e.g., as determined by state monitor 802). Proceeding to decision block 1204, it may be determined whether the drift for the component exceeds a threshold drift from the target state for the component. If the drift for the component does not exceed the threshold, the process flow 1200 may return to block 1202. It will be appreciated that, in some embodiments, a delay may occur before the drift of the component is determined again, such as a period of time or until a request for an updated drift determination occurs, such as based on user input.

If the drift for the component exceeds the threshold drift, the process flow 1200 may proceed to block 1208 and block 1206. At block 1208, the drift record for the component may be generated and/or updated and a user dashboard (e.g., drift GUI view 1100) may be updated to reflect the new drift value. At block 1206, the sources of the drift may be analyzed. For example, drift administrator 902 may analyze the sources of drift. In some embodiments, a risk target distribution delta for the component may be utilized to determine the source of drift. In some such embodiments, determining the risk target distribution delta for the component may include determining the projection of the current component state embedding (e.g., current component state embedding 1004) to a risk target distribution point (e.g., test measurement projection 1010) on an acceptable risk plane (e.g., acceptable risk plane 1006) along the direction of its normal. The difference between the current component state embedding and the risk target distribution point, called the risk target distribution delta, defines the optimal correction to the current component state embedding to the acceptable risk plane. Further, the line connecting the risk target distribution point (e.g., test measurement projection 1010) and the intersection of the current component state embedding (e.g., test measurement intersection 1008) can be used to analyze the basis posture, which measures the similitude between the current component state embedding and the implicit relationships defined by the acceptable risk planes basis vectors. For example, in conjunction with the affine subspace model shown in equation 8, the basis posture can be used to analyze control efficiency through the relative contribution of impact toward the risk target distribution. Continuing to block 1212, one or more remedial actions may be recommended. For example, system manager 214 may recommend one or more remedial actions. In some embodiments, the process flow 1200 may obtain authorization for performing the one or more remedial actions. For example, the dashboard may be updated to request authorization for performing the remedial actions. In some embodiments, the user may select one or more of the recommended remedial actions. At block 1216, the authorized remedial actions may be implemented. The authorized remedial actions may be implemented by calling one or more workflows. For example, block 1218a may correspond to a first workflow called and block 1218b may correspond to a second workflow called. The first workflow may result in a first task being performed at block 1220 and a second block being performed at block 1222. The second workflow may result in a third and fourth task being performed in parallel. Accordingly, workflows may cause various tasks to be performed in series or in parallel to efficiently return a component to a lower drift state.

At decision block 1228 it may be determined whether the remedial actions have been completed. If the remedial actions have not been completed, the process flow 1200 may wait for them to complete. If the remedial actions have been completed, the process flow 1200 may proceed to block 1230. At block 1230 an updated drift determination may be performed. For example, drift administrator 210 may update the drift value for the component. Proceeding to decision block 1232 it may be determined whether the drift of the component was returned to an acceptable level. For example, the updated drift for the component may be compared to the threshold level of acceptable drift. If the component drift has returned to an acceptable level (e.g., below the threshold), then the process flow 1200 may proceed to block 1208 and block 1210, where the drift record for the component is updated and the dashboard is updated. If the component drift has not returned to an acceptable level (e.g., above the threshold), then the process flow 1200 may return to block 1206 and block 1208. At block 1208, the drift record may be updated. In many embodiments, the drift record may be utilized to perform continual learning, such as to improve future remedial action recommendations. In various embodiments, the drift record may be utilized to project future drift of a component, which may be utilized to anticipate needs for a component. At block 1206, the source of drift for the updated drift value may be analyzed to recommend further remedial actions.

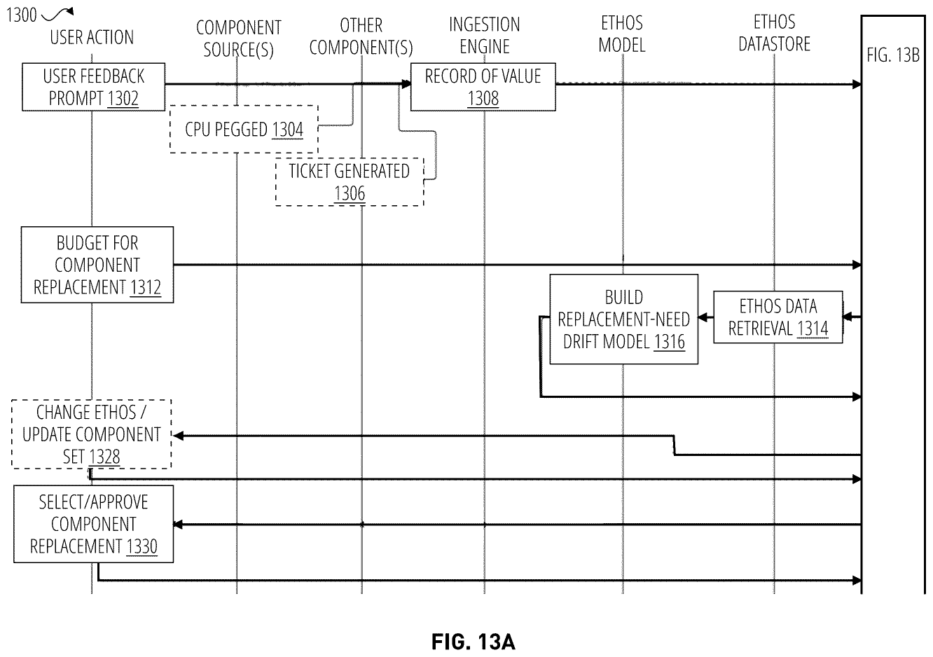

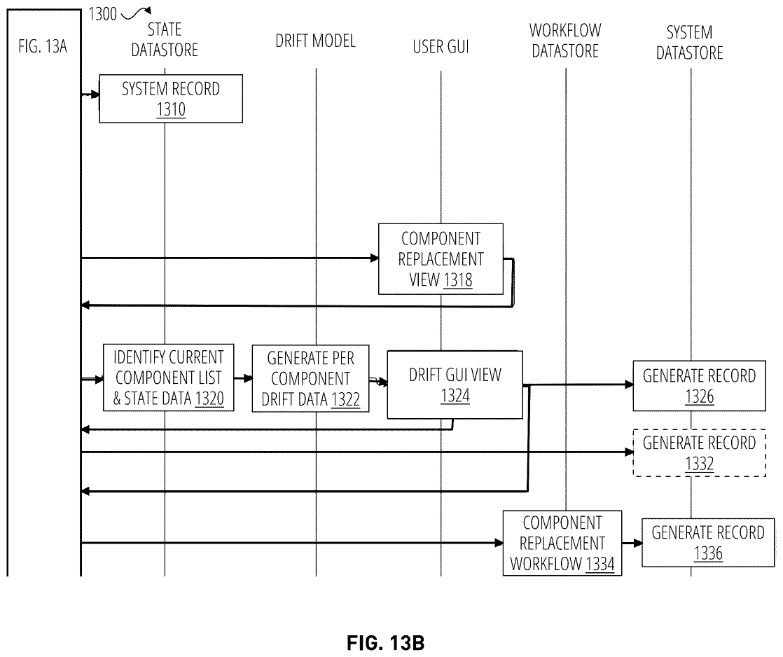

FIGS. 13A and 13B illustrate various functional aspects of an EM system according to some embodiments. More specifically, FIGS. 13A and 13B illustrate interactions between various components of an EM system, such as to determine feedback for continual learning or performing drift queries. The illustrated embodiment shows a diagram 1300 that includes user action, component sources, other components, ingestion engine, ethos model, ethos datastore, state datastore, drift model, user GUI, workflow datastore, and system datastore. In various embodiments, the portions illustrated with dashed lines may be optional. It will be appreciated that one or more components of FIGS. 13A and 13B may be the same or similar to one or more other components disclosed herein. For example, the ethos datastore, state datastore, and system datastore may be included in datastores 204 and/or correspond to information included in client system data 302. In another example, the ingestion engine may be included system utilities 716. Further, aspects discussed with respect to various components in FIGS. 13A and 13B may be implemented by one or more other components from one or more other embodiments without departing from the scope of this disclosure. Embodiments are not limited in this context.

In diagram 1300, blocks 1302, 1304, 1306, 1308, 1310 may correspond to determining feedback for continual learning. For example, user feedback prompt 1302, CPU pegged 1304, and ticket generated 1306 may be provided to the ingestion engine. The ingestion engine may generate a record of value 1308. The record of value 1308 may be stored in the state datastore as system record 1310. The user feedback prompt 1302 may include user feedback regarding how an issue was handled (e.g., were desirable remedial actions performed).

In diagram 1300, blocks 1312, 1314, 1316, 1318, 1320, 1322, 1324, 1326, 1328, 1330, 1332, 1334, 1336 may correspond to a drift query. For example, the drift query may seek to determine which laptops should be replaced with a given budget. At budget for component replacement 1312, the system may determine the budget for the component replacements based on user input. Next, the component replacement view 1318 may be presented to the user, such as via GUI administrator 712. The relevant ethos data may then be retrieved from the ethos datastore at ethos data retrieval 1314. Next, a drift model in which drift corresponds to replacement need may be generated at build replacement-need drift model 1316. The current component list and state data for the laptops in the client system may be retrieved from the state datastore at identify current component list & state data 1320. Generate per component drift data 1322 may then be performed via the drift model. This may include the full component list mapped against the drift model and weighted by the ethos model. Drift GUI view 1324 may then be generated via the GUI (see e.g., drift GUI view 1100). A record of the values and data may be generated in the system datastore at 1326. Optionally, the client ethos and/or component set may be modified at 1328. For example, a user may determine laptops that should be replaced are included in the GUI view. In another example, a user may determine to adjust the client ethos in order to better align the EM system with the client priorities. If the client ethos and/or component set is modified at change ethos/update component set 1328, then the system may generate record 1332 to reflect the changes in the system datastore. At select/approve component replacement 1330, the user may select and approve which components should be replaced based on the GUI view. In response, one or more component replacement workflow 1334 may be performed and records in the system datastore may be updated accordingly at 1336.

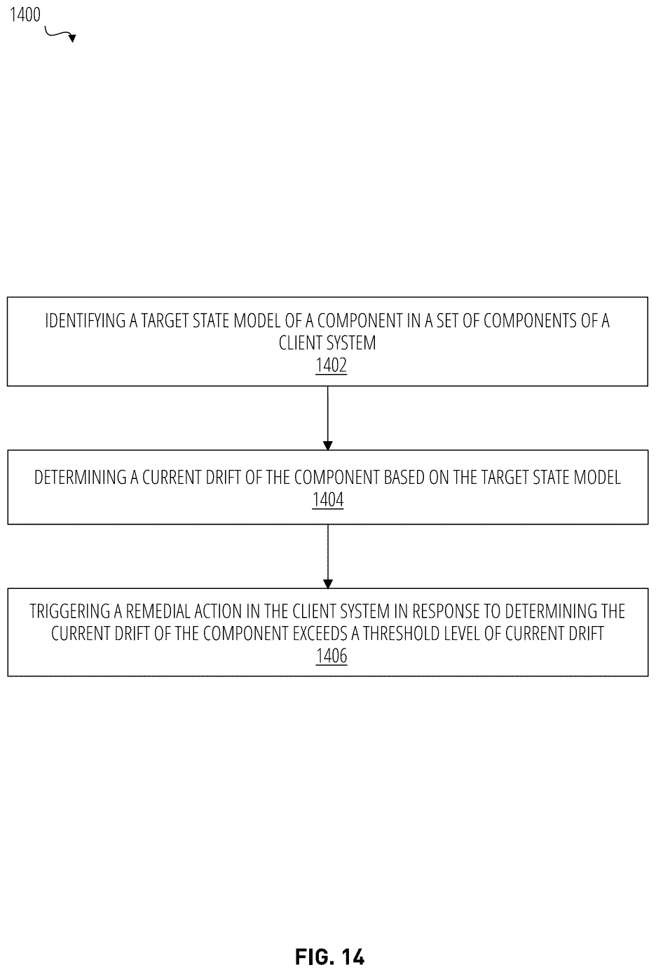

FIG. 14 illustrates a logic flow 1400 of a method for intelligent state monitoring and control according to some embodiments. The process flow 600 is performed by processing logic that may comprise hardware (circuitry, dedicated logic, etc.), software (such as is run on a general purpose computer system or a dedicated machine), firmware, or a combination. In various embodiments, the process flow 600 is performed by one or more of a distributed services system (e.g., distributed services system 104), a server system (e.g., server computer system 110), and an EM system (e.g., EM system 112 or EM system 202). Embodiments are not limited in this context.

Referring to FIG. 14, the logic flow 1400 begins at block 1402. At block 1402, a target state model of a component in a set of components of a client system may be identified. For example, drift administrator 210 may identify a target state model of a component in system component set 304. In some embodiments, the target state model of the component may be identified in response to expiration of a timer, such as a timer for periodically checking the drift of the component.

Continuing to block 1404, a current drift of the component may be determined based on the target state model. For example, drift administrator 902 may determine the current drift of a component based on a corresponding target state model. Proceeding to block 1406, a remedial action in the client system may be triggered in response to determining the current drift of the component exceeds a threshold level of current drift. For example, remediation controller 212 may trigger a remedial action in the client system in response to the current drift of the component exceeding a threshold level of current drift included in datastores 204. In some embodiments, the remedial action may include allocating additional processing or storage resources to the component.

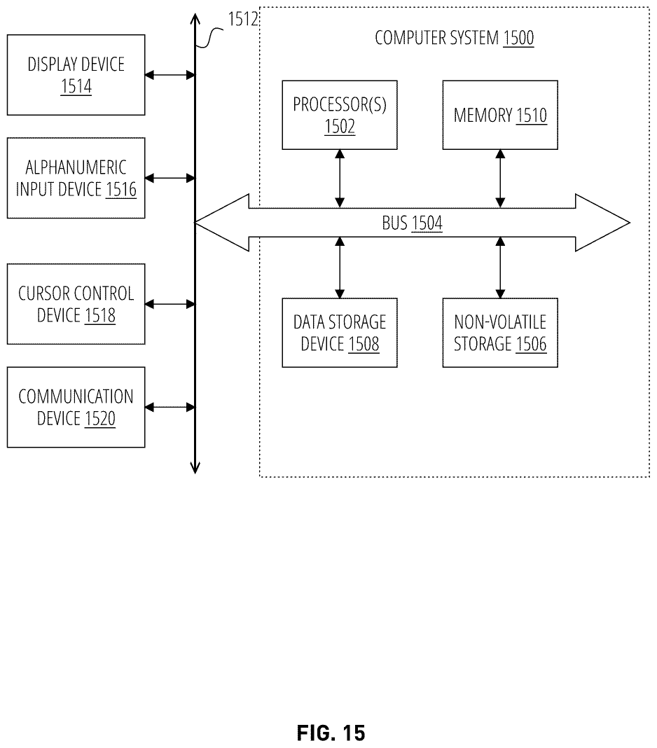

FIG. 15 is one embodiment of a computer system that may be used to support the systems and operations discussed herein. For example, the computer system illustrated in FIG. 15 may be used by a platform system, a server system, a job data pipeline, a subscriber system, a user system, etc. It will be apparent to those of ordinary skill in the art, however that other alternative systems of various system architectures may also be used.

The data processing system illustrated in FIG. 15 includes a bus or other internal communication means 1504 for communicating information, and one or more processors 1502 coupled to the bus 1504 for processing information. The system further comprises a random access memory (RAM) or other volatile storage device (referred to as memory 1510), coupled to bus 1504 for storing information and instructions to be executed by processor 1502. Memory 1510 (e.g., main memory) also may be used for storing temporary variables or other intermediate information during execution of instructions by processor 1502. The system also comprises non-volatile storage 1506 (e.g., read only memory (ROM) and/or static storage device) coupled to bus 1504 for storing static information and instructions for processor 1502, and a data storage device 1508 such as a magnetic disk or optical disk and its corresponding disk drive. Data storage device 1508 is coupled to bus 1504 for storing information and instructions.

The system may further be coupled to a display device 1514, such as a light emitting diode (LED) display or a liquid crystal display (LCD) coupled to bus 1504 through bus 1512 for displaying information to a computer user. An alphanumeric input device 1516, including alphanumeric and other keys, may also be coupled to bus 1504 through bus 1512 for communicating information and command selections to processor 1502. An additional user input device is cursor control device 1518, such as a touchpad, mouse, a trackball, stylus, or cursor direction keys coupled to bus 1504 through bus 1512 for communicating direction information and command selections to processor 1502, and for controlling cursor movement on display device 1514.

Another device, which may optionally be coupled to computer system 1500, is a communication device 1520 for accessing other nodes of a distributed system via a network. The communication device 1520 may include any of a number of commercially available networking peripheral devices such as those used for coupling to an Ethernet, token ring, Internet, or wide area network. The communication device 1520 may further be a null-modem connection, or any other mechanism that provides connectivity between the computer system 1500 and the outside world. Note that any or all of the components of this system illustrated in FIG. 15 and associated hardware may be used in various embodiments as discussed herein.

It will be appreciated by those of ordinary skill in the art that any configuration of the system may be used for various purposes according to the particular implementation. The control logic or software implementing the described embodiments can be stored in memory 1510 (e.g., main memory), data storage device 1508 (e.g., mass storage device), non-volatile storage 1506 (e.g., ROM), or other storage medium locally or remotely accessible to processor 1502.

It will be apparent to those of ordinary skill in the art that the system, method, and process described herein can be implemented as software stored in memory 1510, non-volatile storage 1506, and/or data storage device 1508 and executed by processor 1502. This control logic or software may also be resident on an article of manufacture comprising a computer readable medium having computer readable program code embodied therein and being readable by the data storage device 1508 and for causing the processor 1502 to operate in accordance with the methods and teachings herein.

The embodiments discussed herein may also be embodied in a handheld or portable device containing a subset of the computer hardware components described above. For example, the handheld device may be configured to contain only the bus 1504, the processor 1502, and memory 1510 and/or non-volatile storage 1506. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation of embodiments for such a device would be apparent to one of ordinary skill in the art given the disclosure as provided herein.

The embodiments discussed herein may also be embodied in a special purpose appliance including a subset of the computer hardware components described above. For example, the appliance may include a processor 1502, a data storage device 1508, a bus 1504, and memory 1510, and only rudimentary communications mechanisms, such as a small touch-screen that permits the user to communicate in a basic manner with the device. In general, the more special-purpose the device is, the fewer of the elements need be present for the device to function.

There are a number of example embodiments described herein.

Example 1 is a computer-implemented method, comprising: identifying a target state model of a component in a set of components of a client system; determining a current drift of the component based on the target state model; and triggering a remedial action in the client system in response to determining the current drift of the component exceeds a threshold level of current drift.

Example 2 is the computer-implemented method of Example 1 that may optionally include generating the target state model of the component based on an ethos of a client associated with the client system, wherein the ethos includes a set of objectives with each objective in the set of objectives defined by contents of a first data structure comprising a hierarchical arrangement of at least one attribute, fact, metric, and expected value.

Example 3 is the computer-implemented method of Example 2 that may optionally include that generating the target state model of the component based on the ethos of the client further comprises: identifying a template for a target state of the component based on the ethos of the client and a type of the component, the template for the target state of the component including a second data structure comprising a second hierarchical arrangement of at least one attribute, fact, metric, and expected value; defining the target state of the component by populating contents of the second data structure based on the ethos, the component, and the template; determining a set of weights for the target state of the component based on the ethos of the client; determining a set of drift sensitivities for the target state of the component based on the ethos of the client; and generating the target state model for the component based on the component, the target state, the set of weights, and the set of drift sensitivities.

Example 4 is the computer-implemented method of Example 1 that may optionally include that determining a current drift of the component based on the target state model comprises: determining a current state of the component comprising a set of current values for a set of metrics associated with a target state of the component; generating an input for the target state model based on the set of current values; and providing the input to the target state model to produce the current drift of the component.

Example 5 is the computer-implemented method of Example 4 that may optionally include that the input for the target state model comprises an component state embedding in a vector space comprising a set of dimensions, the set of dimensions including a first dimension corresponding to impact of a negative outcome on the client system caused by drift of the component, a second dimension corresponding to expectancy of the negative outcome on the client system caused by drift of the component, and a third dimension corresponding to control over preventing the negative outcome on the client system caused by drift of the component.

Example 6 is the computer-implemented method of Example 5 that may optionally include that determining the current drift of the component exceeds the threshold level of current drift includes: determining an acceptable risk plane in the vector space based on the target state of the component; projecting a point onto the acceptable risk plane from the component state embedding; and determining a distance between the point projected onto the acceptable risk plane and the component state embedding exceeds a threshold distance.

Example 7 is the computer-implemented method of Example 6 that may optionally include: determining a target risk distribution delta for the component state embedding; and determining a source of the current drift based on the target risk distribution delta.

Example 8 is the computer-implemented method of Example 7 that may optionally include that determining the target risk distribution delta for the current drift comprises: determining a projection of the component state embedding on to the acceptable risk plane along its normal; and determining similitudes between line connecting the projection and intersection of the component state embedding and the acceptable risk planes basis vectors.

Example 9 is the computer-implemented method of Example 1 that may optionally include that the target state model is based on at least one of a fault, configuration, accounting, performance, security (FCAPS) model, a user experience model, a service quality model, and an infrastructure maturity model.

Example 10 is the computer-implemented method of Example 1 that may optionally include that the threshold level for the current drift is determined based on an ethos of a client associated with the client system.

Example 11 is the computer-implemented method of Example 1 that may optionally include: determining a future drift of the component based on the current drift of the component and a set of historical drifts of the component; and triggering an alert in the client system in response to the future drift of the component exceeding a threshold level of future drift.

Example 12 is the computer-implemented method of Example 1 that may optionally include that triggering a remedial action in the client system in response to the current drift of the component exceeding a threshold level of current drift comprises: identifying a set of remedial action options based on the component and the current drift of the component, the set of remedial action options including a first remedial action option and a second remedial action option; presenting the first and second remedial action options via a user interface; and determining a selected remedial action as the first remedial action option based on user input received via the user interface; and performing the selected remedial action.

Example 13 is the computer-implemented method of Example 12 that may optionally include modifying identification of remedial action options based on the selected remedial action, wherein modifying identification of remedial actions increases a likelihood that the first remedial action option is included in a future set of remedial action options identified based on the component and the current drift of the component.

Example 14 is the computer-implemented method of Example 12 that may optionally include modifying identification of remedial action options based on the selected remedial action, wherein modifying identification of remedial actions decreases a likelihood that the second remedial action option is included in a future set of remedial action options identified based on the component and the current drift of the component.

Example 15 is the computer-implemented method of Example 1 that may optionally include that triggering a remedial action in the client system in response to the current drift of the component exceeding a threshold level of current drift comprises: identifying a source of the current drift; determining the remedial action based on the source of the current drift; and initiating performance of the remedial action.

Example 16 is the computer-implemented method of Example 1 that may optionally include that the remedial action comprises a first remedial action, the current drift comprises a previous current drift, and the method further comprising: identifying the first remedial action has been performed; determining an updated current drift of the component based on the target state model in response to performance of the first remedial action; and triggering a second remedial action in response to the updated current drift of the component exceeding the threshold level of current drift.

Example 17 is the computer-implemented method of Example 1 that may optionally include that the remedial action comprises updating software of the component.

Example 18 is the computer-implemented method of Example 1 that may optionally include that the remedial action comprises replacement of the component.

Example 19 is the computer-implemented method of Example 1 that may optionally include that the remedial action comprises rerouting traffic from the component to another component.

Example 20 is the computer-implemented method of Example 1 that may optionally include that the remedial action comprises allocating additional compute resources to the component.

Example 21 is the computer-implemented method of Example 1 that may optionally include that the component of the client system comprises a sentiment regarding the client system.

Example 22 is the computer-implemented method of Example 1 that may optionally include that the component of the client system comprises a computing device of the client system.

Example 23 is an apparatus comprising a processor and a memory storing instructions that, when executed by the processor, cause the processor to perform the computer-implemented method of any of Examples 1 to 22.

Example 24 is a non-transitory machine-readable medium storing computer-executable program code instructions that, when executed by a computing apparatus, cause the computing apparatus to perform the computer-implemented method of any of Examples 1 to 22.

It is to be understood that the above description is intended to be illustrative, and not restrictive. Many other embodiments will be apparent to those of skill in the art upon reading and understanding the above description. The scope should, therefore, be determined with reference to the appended claims, along with the full scope of equivalents to which such claims are entitled.

The foregoing description, for purpose of explanation, has been described with reference to specific embodiments. However, the illustrative discussions above are not intended to be exhaustive or to limit the described embodiments to the precise forms disclosed. Many modifications and variations are possible in view of the above teachings. The embodiments were chosen and described in order to best explain the principles and practical applications of the various embodiments, to thereby enable others skilled in the art to best utilize the various embodiments with various modifications as may be suited to the particular use contemplated.

What is claimed is:

1. A computer-implemented method, comprising:
identifying a target state model of a component in a set of components of a client system;
determining a current drift of the component based on the target state model; and
triggering a remedial action in the client system in response to determining the current drift of the component exceeds a threshold level of current drift.

2. The method of claim 1, further comprising generating the target state model of the component based on an ethos of a client associated with the client system, wherein the ethos includes a set of objectives with each objective in the set of objectives defined by contents of a first data structure comprising a hierarchical arrangement of at least one attribute, fact, metric, and expected value.

3. The method of claim 2, wherein generating the target state model of the component based on the ethos of the client further comprises:
identifying a template for a target state of the component based on the ethos of the client and a type of the component, the template for the target state of the component including a second data structure comprising a second hierarchical arrangement of at least one attribute, fact, metric, and expected value;
defining the target state of the component by populating contents of the second data structure based on the ethos, the component, and the template;
determining a set of weights for the target state of the component based on the ethos of the client;
determining a set of drift sensitivities for the target state of the component based on the ethos of the client; and
generating the target state model for the component based on the component, the target state, the set of weights, and the set of drift sensitivities.

4. The method of claim 1, wherein determining a current drift of the component based on the target state model comprises:
determining a current state of the component comprising a set of current values for a set of metrics associated with a target state of the component;
generating an input for the target state model based on the set of current values; and
providing the input to the target state model to produce the current drift of the component.

5. The method of claim 4, wherein the input for the target state model comprises an component state embedding in a vector space comprising a set of dimensions, the set of dimensions including a first dimension corresponding to impact of a negative outcome on the client system caused by drift of the component, a second dimension corresponding to expectancy of the negative outcome on the client system caused by drift of the component, and a third dimension corresponding to control over preventing the negative outcome on the client system caused by drift of the component.

6. The method of claim 5, wherein determining the current drift of the component exceeds the threshold level of current drift includes:
determining an acceptable risk plane in the vector space based on the target state of the component;
projecting a point onto the acceptable risk plane from the component state embedding; and
determining a distance between the point projected onto the acceptable risk plane and the component state embedding exceeds a threshold distance.

7. The method of claim 6, further comprising:
determining a target risk distribution delta for the component state embedding; and
determining a source of the current drift based on the target risk distribution delta.

8. The method of claim 7, wherein determining the target risk distribution delta for the current drift comprises:
Determining the projection of the component state embedding and the acceptable risk plane; and determining similitudes between line connecting the projection and intersection of the component state embedding and the acceptable risk planes basis vectors.

9. The method of claim 1, wherein the target state model is based on at least one of a fault, configuration, accounting, performance, security (FCAPS) model, a user experience model, a service quality model, and an infrastructure maturity model.

10. The method of claim 1, wherein the threshold level for the current drift is determined based on an ethos of a client associated with the client system.

11. The method of claim 1, further comprising:
determining a future drift of the component based on the current drift of the component and a set of historical drifts of the component; and
triggering an alert in the client system in response to the future drift of the component exceeding a threshold level of future drift.

12. The method of claim 1, wherein triggering a remedial action in the client system in response to the current drift of the component exceeding a threshold level of current drift comprises:
identifying a set of remedial action options based on the component and the current drift of the component, the set of remedial action options including a first remedial action option and a second remedial action option;
presenting the first and second remedial action options via a user interface; and
determining a selected remedial action as the first remedial action option based on user input received via the user interface; and
performing the selected remedial action.

13. The method of claim 12, further comprising modifying identification of remedial action options based on the selected remedial action, wherein modifying identification of remedial actions increases a likelihood that the first remedial action option is included in a future set of remedial action options identified based on the component and the current drift of the component.

14. The method of claim 12, further comprising modifying identification of remedial action options based on the selected remedial action, wherein modifying identification of remedial actions decreases a likelihood that the second remedial action option is included in a future set of remedial action options identified based on the component and the current drift of the component.

15. The method of claim 1, wherein triggering a remedial action in the client system in response to the current drift of the component exceeding a threshold level of current drift comprises:
identifying a source of the current drift;
determining the remedial action based on the source of the current drift; and
initiating performance of the remedial action.

16. The method of claim 1, wherein the remedial action comprises a first remedial action, the current drift comprises a previous current drift, and the method further comprising:
identifying the first remedial action has been performed;
determining an updated current drift of the component based on the target state model in response to performance of the first remedial action; and
triggering a second remedial action in response to the updated current drift of the component exceeding the threshold level of current drift.

17. An apparatus comprising:
a processor; and
memory storing instructions that, when executed by the processor, cause the processor to:
identify a target state model of a component in a set of components of a client system;
determine a current drift of the component based on the target state model; and
trigger a remedial action in the client system in response to determining the current drift of the component exceeds a threshold level of current drift.

18. The apparatus of claim 17, wherein the memory further stores instructions that, when executed by the processor, cause the processor to generate the target state model of the component based on an ethos of a client associated with the client system, wherein the ethos includes a set of objectives with each objective in the set of objectives defined by contents of a first data structure comprising a hierarchical arrangement of at least one attribute, fact, metric, and expected value.

19. At least one non-transitory computer-readable storage medium storing computer-executable program code instructions that, when executed by a computing apparatus, cause the computing apparatus to:
identify a target state model of a component in a set of components of a client system;
determine a current drift of the component based on the target state model; and
trigger a remedial action in the client system in response to determining the current drift of the component exceeds a threshold level of current drift.

20. The at least one non-transitory computer-readable storage medium of claim 19, wherein the computer-executable program code instructions, when executed by the computing apparatus, further cause the computing apparatus to generate the target state model of the component based on an ethos of a client associated with the client system, wherein the ethos includes a set of objectives with each objective in the set of objectives defined by contents of a first data structure comprising a hierarchical arrangement of at least one attribute, fact, metric, and expected value.
